(19) United States
(12) Patent Application Publication
(10) Pub. No.: US 2024/0070789 A1
(43) Pub. Date: Feb. 29, 2024

(54) CONTROLLING PROJECT CONTRIBUTION, INITIATION, AND/OR DISTRIBUTION THROUGH DATA STRUCTURING OF A CONTINGENT PROJECT OBJECT

(71) Applicant: Neon Wind Ventures, LLC, Sheridan, WY (US)

(72) Inventor: Peter Jenson, Wintergarden, FL (US)

(73) Assignee: Neon Wind Ventures, LLC, SHERIDAN, WY (US)

(21) Appl. No.: 17/897,177

(22) Filed: Aug. 28, 2022

(51) Int. Cl. G06Q 50/00; G06Q 10/06; G06Q 20/38

(52) U.S. Cl. CPC G06Q 50/01; G06Q 10/06313; G06Q 10/06316; G06Q 20/389

(57) ABSTRACT

Disclosed is a method, a device, a system and/or a manufacture of controlling project contribution, initiation, and/or distribution through data structuring of a contingent project object. In one embodiment, a system for electronic data structuring and management of crowd sourced projects includes a project structuring engine that generates a contingent project object. A contribution condition subroutine defines a contribution condition for an electronically verifiable contribution to the contingent project object. An initiation condition creation subroutine defines an initiation action that is self-executing upon a determination by an initiation evaluation routine that an initiation criteria has been met. The distribution condition generation routine defines a first distribution condition data including a first distribution action that is self-executing when the first distribution criteria has been met. The system may include a node server communicatively coupled to a distributed ledger technology network where the contingent project object may further include a self-executing contract.

### FIELD OF TECHNOLOGY

This disclosure relates generally to data processing devices and, more particularly, to a method, a device, and/or a system of controlling project contribution, initiation, and/or distribution through data structuring of a contingent project object.

### BACKGROUND

A project may have various forms of contributors who may contribute one or more forms of value in order to increase a likelihood a project succeeds. For example, some contributions may be include money or currency of any kind such as fiat currency, cryptocurrency, etc.; some may be the transfer of ownership of or granting of access or privileges to one or more assets which can be any item or resource whatsoever, such as physical assets (e.g. physical property), digital assets including but not limited to non-fungible tokens, and/or intangible assets such as branding, intellectual property, information, data, etc.; and some may be services (a “service contribution”) which can be the accomplishment of any kind of action(s) or goal(s) such as the provision of social influence (e.g., endorsement, connections, authority), the provision of knowledge or expertise (e.g., business knowledge, engineering, legal expertise, statistical modeling skill), the provision of time and/or effort (e.g. manually inputting numbers into a spreadsheet, leveling up a character or carrying out some other repetitive activity in a video game, etc.), and/or the accomplishment of one or more tasks (e.g. the creation of a useful spreadsheet); and some may be a contribution of some other kind such as a combination of the aforementioned. The project, for example, may be building a new consumer product, engaging in scientific research, endeavoring in a new business venture, funding a building for a community, investing in a publicly traded market such as stocks, cryptocurrencies, Non-Fungible Tokens (NFTs), etc., and other projects that may require resources to complete. In the formation and carrying out of the project, one challenge may be ensuring the needs of the project, its necessary resources for success, and the desired outcome are clear and remain consistent.

Some online platforms have been able to assist the organization of projects. However, there is a continuing need for more powerful and/or versatile technology that may be useful to assist in the management, maintenance, and execution of projects and their resources.

### SUMMARY

Disclosed are a method, a device, and/or a system of controlling contribution, initiation, and/or distribution of a project through structuring of a contingent project object.

In one embodiment, a system for electronic data structuring and management of crowd sourced projects includes a project server include and a network communicatively coupled to the project server. The project server includes a processor of the project server, a memory of the project server, a project database, a project initialization routine, and a project structuring engine.

The project database stores a contingent project object that includes a unique identifier of the contingent project object that is a computer readable string, a project title that is human readable, and a first referential attribute referencing a user profile of a first user. The project initialization routine includes computer readable instructions that when executed receive an initialization request from a client device the first user.

The project structuring engine includes computer readable instructions that when executed generate the contingent project object. The project structuring engine further includes a contribution condition subroutine, an initiation condition creation subroutine, an initiation data source designation subroutine, a distribution condition generation routine, and a distribution data source designation subroutine. The contribution condition subroutine includes computer readable instructions that when executed define a contribution condition for a plurality of users to contribute to the contingent project object, the contribution condition including a monetary contribution that is electronically verifiable, an asset contribution that is electronically verifiable, and/or a service contribution that is electronically verifiable.

The initiation condition creation subroutine includes computer readable instructions that when executed define an initiation condition data including an initiation action and an initiation criteria, where the initiation action is self-executing upon a determination by an initiation evaluation routine that the initiation criteria has been met. The initiation data source designation subroutine includes computer readable instructions that when executed select an initiation data source including an initiation data necessary, as a first input to the initiation evaluation routine, to an evaluation of whether the initiation criteria has been met. The distribution condition generation routine including computer readable instructions that when executed define a first distribution condition data including a first distribution action and a first distribution criteria. The first distribution action is self-executing upon a determination by a distribution evaluation routine that the first distribution criteria has been met. The distribution data source designation subroutine includes computer readable instructions that when executed select a first distribution data source as a second input to the distribution evaluation routine, the first distribution data source including a distribution data that is necessary to an evaluation of whether the first distribution criteria has been met.

The system may also include a condition server that includes a processor of the condition server, a memory of the condition server, and a contribution engine. The condition contribution engine may include a contribution receipt agent, a contribution evaluation routine, a subscription routine, an initiation engine, and a distribution engine. The contribution receipt agent may include computer readable instructions that when executed receive a contribution request from a second user of the plurality of users to contribute the monetary contribution, the asset contribution, and/or the service contribution to the contingent project object. The contribution evaluation routine may include computer readable instructions that when executed determine the contribution condition has been met.

The subscription routine may include computer readable instructions that when executed store a unique identifier of a user profile of the second user in a second referential attribute and associate the unique identifier of the user profile of the second user with the first distribution condition data. The initiation engine may include the initiation evaluation routine. The initiation evaluation routine may also include computer readable instructions that when executed determine the initiation criteria has been met. The distribution engine may include computer readable instructions that when executed determine the first distribution criteria has been met and initiate the first distribution action.

The system may also include a user profile server communicatively coupled to the network, the client device, including a processor of the user profile server, a memory of the user profile server, a profile database, and an authentication system. The profile database may store the user profile of the first user, the user profile of the first user may include a user UID of the user profile of the first user, a social profile reference, and a project reference. The authentication system may include computer readable instructions that when executed authenticate the first user associated with the user profile of the first user.

The system may also include the client device. The client device may be communicatively coupled to the network and include a processor of the client device, a memory of the client device,

And a project creation application including computer readable instructions that when executed generate the initialization request that includes the user UID of the user profile of the first user.

The condition server may further include a random number generation routine that generates a random number utilizing an entropy source. The distribution condition generation routine may further include computer readable instructions that when executed generate a transaction window defining a third distribution action. The transaction window may initiate the third distribution action at a random time for a subset of the plurality of users. The subset of the plurality of users may be based on at least one of a user type, a contribution type contributed by the subset of the plurality of users, a length of association with the contingent project object, and/or a random group. The distribution evaluation routine further includes computer readable instructions that when generated initiate the transaction window.

The system may further include a node server communicatively coupled to the network and a distributed ledger network. The contingent project object may further include a self-executing contract stored in a distributed ledger database on the node server of the distributed ledger network. The contribution condition may specify: (i) a transfer of a cryptocurrency value into control of the contingent project object, (ii) a transfer of a digital token into control of the contingent project object, (iii) a first distributed ledger transaction locking the cryptocurrency value in association with the contingent project object, and/or (iv) a second distributed ledger transaction locking the digital token in association with the contingent project object. The initiation criteria may include the contingent project object controlling: (i) a threshold amount of cryptocurrency value, (ii) a threshold number of digital tokens, (iii) a threshold amount of cryptocurrency value that is locked in association with the contingent project object, and/or (iv) a threshold number of digital tokens that are locked in association with the contingent project object.

The contribution request may be included in a third distributed ledger transaction stored on the distributed ledger database that includes the unique identifier of the contingent project object. A determination that a threshold value has not been met or exceeded within a threshold time including generating a fourth distributed ledger transaction effecting a transfer the cryptocurrency value locked in association with the contingent project object and/or the digital token locked in association with the contingent project object. The random number may be generated at least in part from operation of the distributed ledger network, for example the random number may be generated at least in part by utilizing a block time of the distributed ledger network.

In another embodiment, a method for generating a data structure supporting constrained participation in crowd sourced projects includes authenticating a first user associated with a user profile of the first user and receiving over a network an initialization request from a client device the first user. The method generates a contingent project object including a unique identifier of the contingent project object that is a computer readable string, a project title that is human readable, and a first referential attribute referencing the user profile of the first user. The method defines a contribution condition for a plurality of users to contribute to the contingent project object, the contribution condition including a monetary contribution that is electronically verifiable, an as set contribution that is electronically verifiable, and/or a service contribution that is electronically verifiable. An initiation condition data is defined that includes an initiation action and an initiation criteria, where the initiation action is self-executing upon a determination by an initiation evaluation routine that the initiation criteria has been met.

The method selects an initiation data source that includes an initiation data necessary, as a first input to the initiation evaluation routine, to an evaluation of whether the initiation criteria has been met. The initiation data source includes data stored in association with the contingent project object and/or a first API to an external data source. A first distribution condition data is defined that includes a first distribution action and a first distribution criteria, where the first distribution action is self-executing upon a determination by a distribution evaluation routine that the first distribution criteria has been met. A first distribution data source is selected as a second input to the distribution evaluation routine. The first distribution data source includes a distribution data that is necessary to an evaluation of whether the first distribution criteria has been met.

The method may include generating a project constraint data that includes the project title, an initiation description of the initiation criteria automatically translated from the initiation criteria, and a distribution description of the first distribution criteria automatically translated from the first distribution criteria. The project constraint data may be transmitted to a server computer accessible by one or more of the plurality of users to describe participation constraints of a set of self-executing properties of the contingent project object.

The method may receive a contribution request from a second user of the plurality of users to contribute at least one of the monetary contribution, the asset contribution, and/or the service contribution to the contingent project object. After determining the contribution condition has been met, a unique identifier of a user profile of the second user may be stored in a second referential attribute, and the unique identifier of the user profile of the second user may be associated with the first distribution condition data.

The method may also define a second distribution condition data and constrain the second distribution condition data such that a second distribution action is only performed upon completion of the first distribution action. The method may (i) disallow association of the user profile of the first user with the first distribution condition data, and/or (ii) un-associate a unique identifier of the user profile of the first user with the first distribution condition data. The unique identifier of the user profile of the first user may be associated with the second distribution condition data. Where it is determined the initiation criteria has not been met, the monetary contribution and/or the asset contribution to each of the plurality of users and the first user may be returned.

A governance ruleset of the contingent project object may be generated. The governance ruleset may include one or more governance rights each associated with: (i) a user type, and/or (ii) a unique identifier of the user profile of one of the plurality of users. A distribution ruleset of the contingent project object may be generated. The distribution ruleset may include a distribution proportion at least partially dependent on: (i) the user type, (ii) a date of the contribution request of the second user; (iii) a numerical value assigned to the monetary contribution, (iv) a numerical value assigned to the asset contribution, and/or (v) a numerical value assigned to the service contribution. The one or more governance rights may include a voting right in proportion to the monetary contribution, the asset contribution, and/or the service contribution. The method may also determine the first distribution criteria has been met and initiate the first distribution action enabling the second user to initiate a fifth distributed ledger transaction transferring a cryptocurrency and/or an electronic token out of the control of the contingent project object.

In yet another embodiment, a method for electronic management of crowd sourced projects includes receiving over a network an initialization request from a client device of a first user and generating a contingent project object that includes a unique identifier of the contingent project object and a first referential attribute referencing the user profile of the first user. The contingent project object is a self-executing contract stored in a distributed ledger database on a node server of a distributed ledger network.

A contribution condition may be defined for a plurality of users to contribute to the contingent project object. The contribution condition includes a monetary contribution that is electronically verifiable, an asset contribution that is electronically verifiable, and/or a service contribution that is electronically verifiable. The method defines an initiation condition data including an initiation action and an initiation criteria, where the initiation action is self-executing upon a determination by an initiation evaluation routine that the initiation criteria has been met.

An initiation data source is selected that includes an initiation data necessary as a first input to the initiation evaluation routine to an evaluation of whether the initiation criteria has been met. The initiation data source includes data stored in association with the contingent project object and/or a first API to an external data source. The method generates a project constraint data including a project title, and an initiation description of the initiation criteria automatically translated from the initiation criteria. The project constraint data may be transmitted to a server computer accessible by one or more of the plurality of users to describe participation constraints of a set of self-executing properties of the contingent project object.

### BRIEF DESCRIPTION OF THE DRAWINGS

The embodiments of this disclosure are illustrated by way of example and not limitation in the figures of the accompanying drawings, in which like references indicate similar elements and in which:

FIG. 1A illustrates a contingent project network in which one or more users may initiate storage and structuring of a contingent project object on a project server, including a contribution condition, an initiation condition, and a distribution condition, and in which one or more additional users may generate a contribution request, including a monetary contribution 116, an asset contribution 118, and/or a service contribution 117 that may be verifiable such as a social media network contribution and/or the completion of any number and/or other types of tasks, and a condition server may evaluate against the contingent project object whether conditions for the contribution, conditions for initiation are met, and/or conditions of distribution are met, according to one or more embodiments.

FIG. 1B illustrates a contingent project data structure including the contingent project object of FIG. 1A, a project constraint data, a contingent contribution contract, and/or a user object (e.g., for a contributing instance of the user), according to one or more embodiments.

FIG. 2 illustrates the project server, including a project structuring engine, a project database, a constraint description engine, and a distribution constraint routine, according to one or more embodiments.

FIG. 3 illustrates the condition server, including a contribution engine that may evaluate a contribution data input, an initiation engine that may evaluate an initiation data input from an initiation data source, and a distribution engine that may evaluate a distribution data input from a distribution data source, according to one or more embodiments.

FIG. 4 illustrates a client device usable by one or more of the users of FIG. 1, including a project creation application for initiating a contingent project object and/or a project participation application for contributing to a contingent project object, according to one or more embodiments.

FIG. 5 illustrates a user profile server including a profile database storing a user profile usable to authenticate a user and/or determine initiation, contribution, and/or distribution associated with a contingent project object, according to one or more embodiments.

FIG. 6 illustrates a distributed ledger and/or blockchain implementation in which the contingent project object may be defined and/or stored in a data block replicated on a node server of a distributed ledger technology (DLT) network, also referred to herein as a “distributed ledger network”, according to one or more embodiments.

FIG. 7 illustrates a contingent project object definition process flow, according to one or more embodiments.

FIG. 8 illustrates a contribution group data structuring process flow, according to one or more embodiments.

FIG. 9 illustrates an initiation data structuring process flow, according to one or more embodiments.

FIG. 10 illustrates a distribution data structuring process flow, according to one or more embodiments.

FIG. 11 illustrates a contribution request evaluation process flow, according to one or more embodiments.

FIG. 12 illustrates a project initiation process flow, according to one or more embodiments.

FIG. 13 illustrates a distribution evaluation process flow, according to one or more embodiments.

FIG. 14 illustrates an example in which a contingent project object is structured, stored, and evaluated, including constrained distribution parameters of initiating users, defining required contributions having verifiable service contributions for a second group of users, and defining required asset contributions for a third group of users, according to one or more embodiments.

Other features of the present embodiments will be apparent from the accompanying drawings and from the detailed description that follows.

### DETAILED DESCRIPTION

Disclosed are a method, a device, and/or system of controlling project contribution, initiation, and/or distribution through data structuring of a contingent project object. Although the present embodiments have been described with reference to specific example embodiments, it will be evident that various modifications and changes may be made to these embodiments without departing from the broader spirit and scope of the various embodiments.

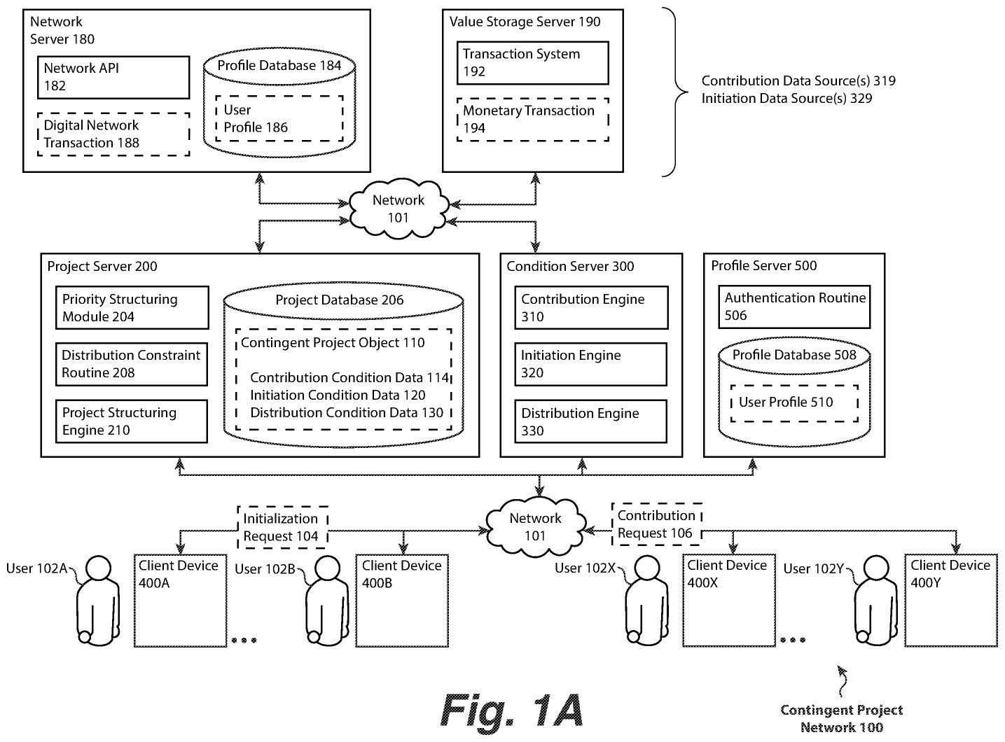

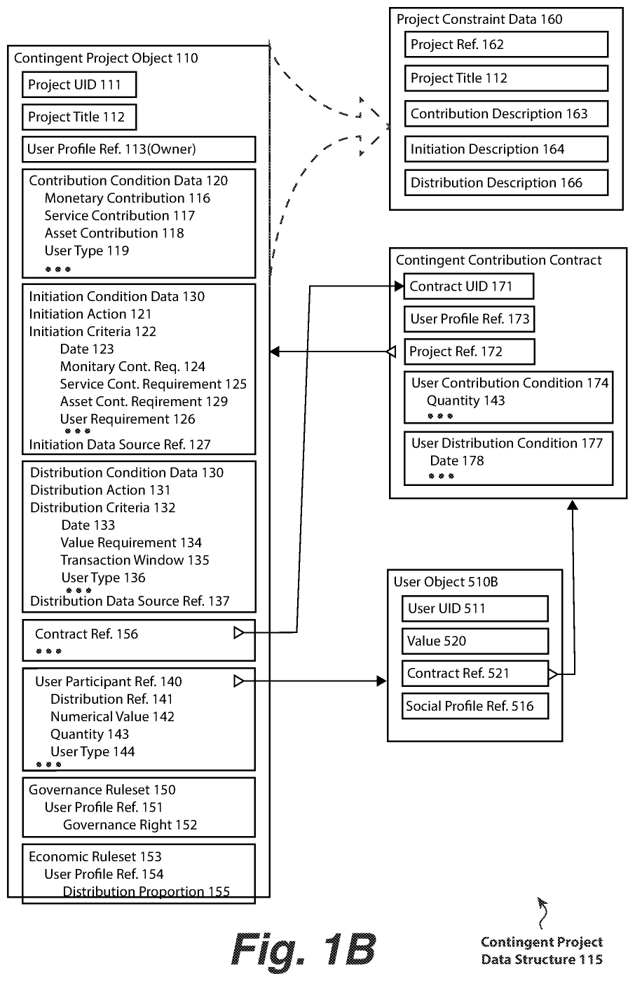

FIG. 1 illustrates a contingent project network, according to one or more embodiments. In one or more embodiments, the contingent project network 100 includes a project server 200, a condition server 300, one or more client devices 400, a user profile server 500, a digital network server 180, and/or a value storage server 190, each communicatively coupled through a network 101. The network 101 may be and/or include a combination of data communication networks, for example, a local area network (LAN), wireless network (e.g., WiFi, LEO satellite networks), a wide area network (WAN), and/or the internet.

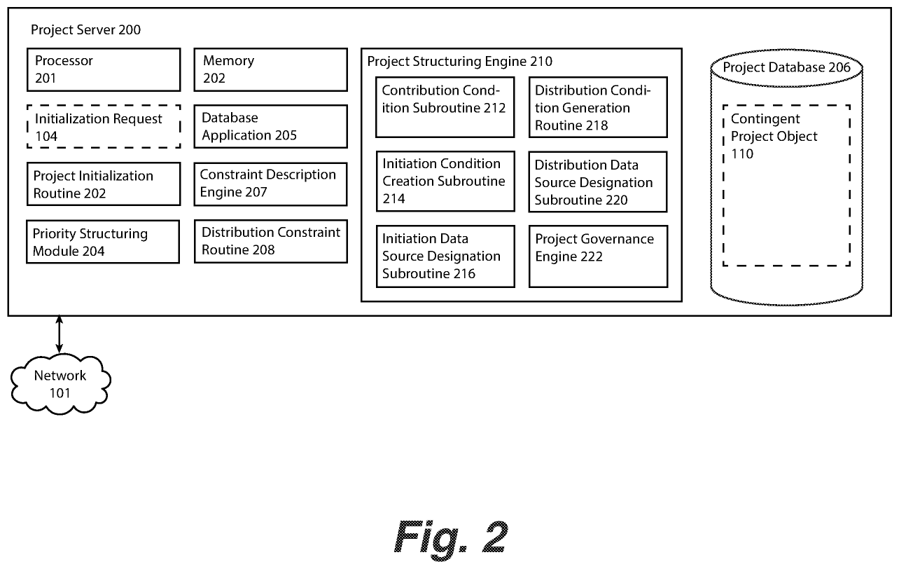

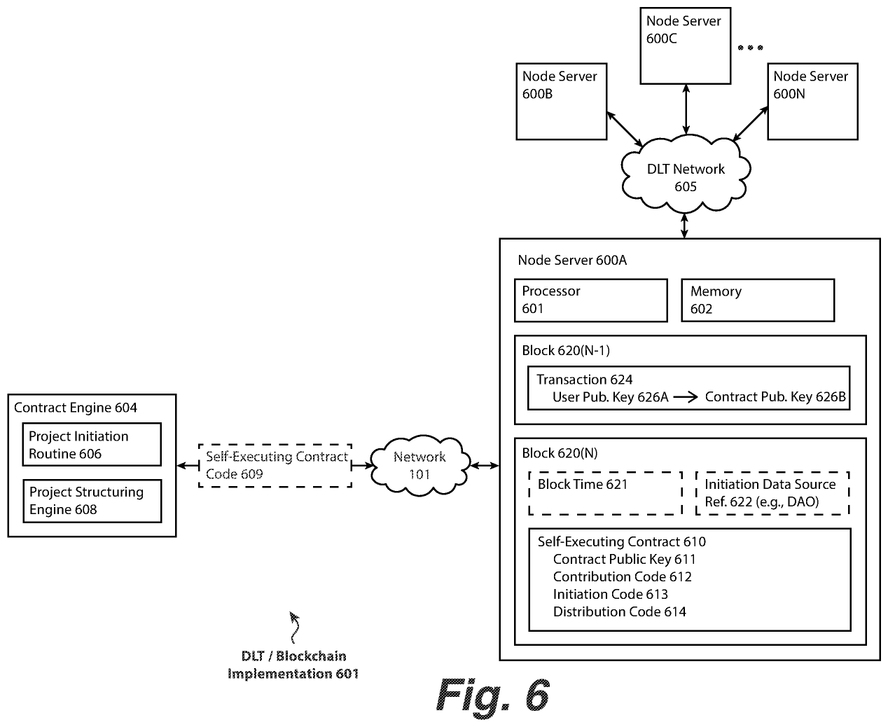

A first set of one or more users 102 (e.g., the user 102A through the user 102B) may generate an initialization request 104 from a client device 400 (e.g., one or more of the client device 400A through the client device 400B). The initialization request 104 may be communicated through the network 101 to the project server 200. A project initialization routine 202 (e.g., as shown and described in conjunction with FIG. 2) may receive the initialization request 104 and initially define a contingent project object 110 in a computer memory, for example within temporary random access memory and/or a project database 206. A project structuring engine 210 may then receive additional constraints, parameters, and/or other data from one or more of a first set of client devices 400 (e.g., one or more of the client device 400A through the client device 400B). The contingent project object 110 is further shown in detail in FIG. 1B, according to one or more embodiments, but may for example include a contribution condition data 114, an initiation condition data 120, and a distribution condition data 130. The contribution condition data 114 may include parameters specifying a type of contribution necessary to participate and/or act as a contribution for the project. In one or more embodiments, the contribution condition data 114 may define a contribution that is electronically verifiable whether through automated or manual means, including for example a service contribution 117 defining certain actions to be taken by a user 102 (e.g., the user 102X) (e.g. on a digital network server 180 such as social media network server) and/or a monetary contribution 116 defining a monetary transaction (e.g. a cryptocurrency transaction) that can be verifiably determined to have occurred, such as in a block 620 of a distribution ledger database (e.g., as further shown and described in conjunction with FIG. 6), and/or any other type of contribution of a user such as an asset contribution 118 or any combination of the aforementioned contribution types. A contribution type may specify, for example, a monetary contribution 116, a service contribution 117, and/or an asset contribution 118, or subtypes (e.g., a foreign currency monetary contribution, an previously rendered verifiable service, a prospective or owed service, a real estate asset, a personal asset, etc.). The initiation condition data 120 may specify conditions that must occur for initiation of the automatic execution of the processes associated with the contingent project object 110, which may coincide with initiation of the project that the contingent project object 110 may model and/or represent in the real world.

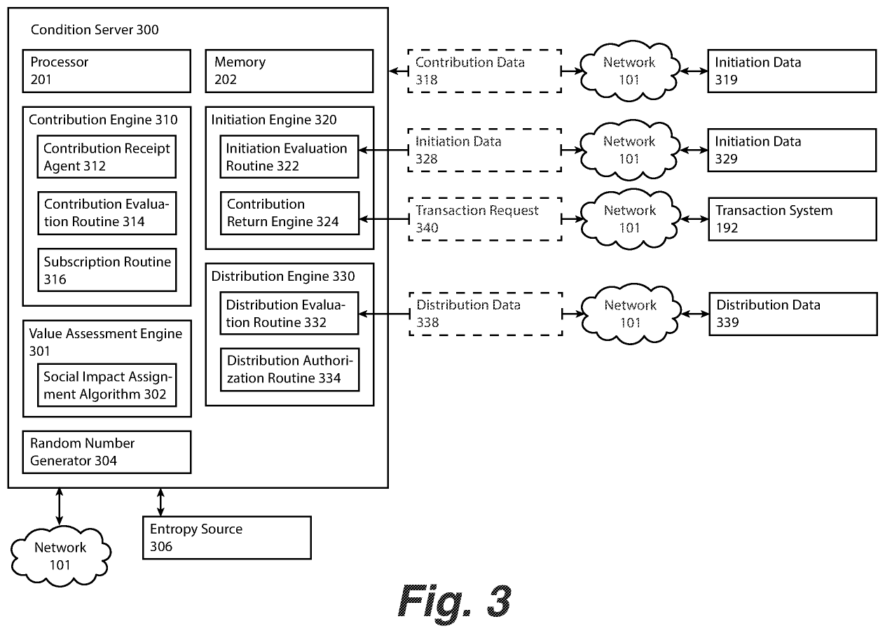

The initiation condition data 120 may specify a data source from which data will be obtained to evaluate the initiation, e.g., the initiation data source 329 as shown and described in conjunction with FIG. 3. As just one example, an initiation condition may require and/or may be structured using Boolean operators such that: a certain threshold number of digital network transactions 188 have occurred (e.g., as may be determined through a social network API); that several contributors with a known expertise are associated with the project (e.g., where such expertise may be determined from a user profile 510 and a database association to the user profile 510 associated with the user 102); and/or that a threshold amount of monetary resources are available (e.g., contributions of currency and/or cryptocurrency). The initiation condition data 120 may allow for complex structuring of conditions that may be automatically and/or rapidly effected, for example allowing the contingent project object 110 to initiate if an evaluation shows a high amount of social media network activity but low monetary resources are available, or, conversely, if low social media network activity is determined but high monetary resources are electronically verified to be available.

The distribution condition data 130 may define conditions under which value or another realized benefit of the project can be distributed to one or more contributors, for example the initializers (e.g., the user 102A through the user 102B) and/or later contributors (e.g., the user 102X through the user 102Y). The distribution condition data 130 may be similarly flexible to the initiation condition data 120, allowing for certain types of distribution actions upon certain electronically verifiable determinations. As just one example, if social network activity remains strong (e.g., as may be determined through a digital network API 182 and/or web page analysis), if a monetary value of the project has reached a certain threshold (e.g., a stock price), and where one or more experts have continued their association with the project (e.g., as determined through a defined database association between the contingent project object 110 and a user profile 510), then one or more distribution actions 131 may occur. In one or more embodiments, a distribution action 131 may be to automatically generate a cryptocurrency transaction on a distributed ledger database (e.g., a transaction 624, as further described in conjunction with FIG. 6).

Following definition of a contingent project object 110, a condition server 300 may receive one or more contribution requests 106 from a client device 400 generated by a user 102. The user 102 may have reviewed data of the contingent project object 110 to be aware of a necessary and/or optional contribution, including through potentially reviewing the project constraint data 160 that may narrate and/or summarize software or database code used in the contingent project object 110, as further described in FIG. 1B. A contribution engine 310 may evaluate the contribution request 106, and any associated requirements, to determine whether the contribution is valid and/or to what extent it provides value. In one or more embodiments, the contribution request 106 may be received, but an association between a user profile 510 of the user 102 and the contingent project object 110 may remain pending until each of one or more conditions are met (e.g. a monetary contribution 116, an asset contribution 118, and/or a service contribution 117, updating the user profile 510 to reflect an expertise asserted by a user 102 but yet not verifiable in a user profile 510, etc.).

In one or more embodiments, the initiation engine 320 may evaluate data from an initiation data source 329 to determine whether an initiation action 121 should occur, as further shown and described in FIG. 3. An initiation condition may require that a certain amount of resource is associated with and/or under the control of the contingent project object 110, for example sufficient monetary resources, sufficient assets such as digital, physical, or intangible resources, and/or sufficient contribution of services such as the provision of expertise, the achievement and/or stimulation of relevant and recent social media activity, the accomplishment of any number and/or type of needed tasks, etc. The initiation action may be to release certain resources to one or more users 102 directly in charge of the contingent project object 110 to effect the associated project (e.g., the user 102A through the user 102B), and/or lock certain contributions of contributors (e.g., the user 102X through the user 102Y).

In one or more embodiments, the distribution engine 330 may evaluate data from a distribution data source 339 to determine whether a distribution condition specified in a distribution criteria 132 has been met and/or a distribution action 131 defined in the contingent project object 110 should automatically execute. The distribution action 131 may, for example, include the distribution of value, automatic generation of a cryptocurrency transaction (or other tokenized transaction), issuance of an encryption key usable to control an electronic system or unencrypt a file or document, a social network post by an initializer of the contingent project object 110 thanking the user 102X for their contribution (e.g., a form of a social value distribution), and/or other forms of distribution. The distribution action 131 may also include, for example, the distribution of value in any form, such as the distribution of an ownership stake (including the possibility of a fractional ownership stake) in and/or access rights and/or other privileges regarding a digital, physical, or intangible item, entity, or resource including but not limited to physical real estate, digital real estate, and/or non-fungible tokens (“NFT”).

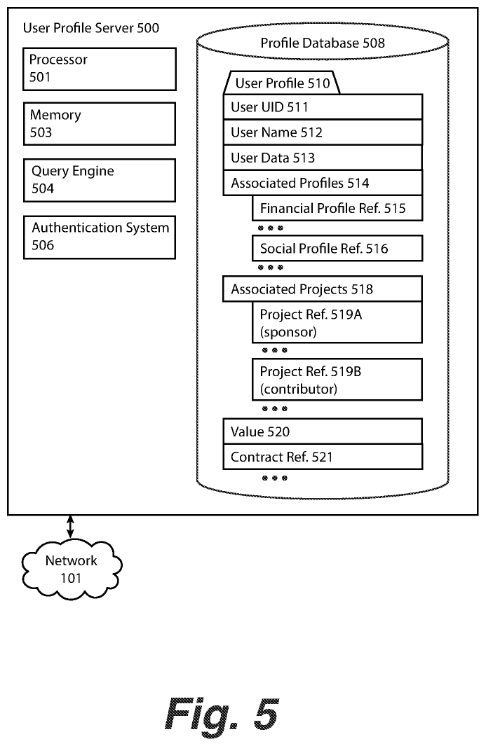

The user profile server 500 may include an authentication system 506 that may be used to authenticate a user 102 (e.g., the user 102A through the user 102Y) initializing, contributing to and/or receiving a distribution. Authentication may assist in ensuring that a user 102 contributing to the contingent project object 110 is, in fact, who they claim to be and/or verify an association between the user 102 and the user profile 510. The user profile server 500 and the user profile 510 are further shown and described in conjunction with the embodiment of FIG. 5. In one or more other embodiment, the distribution action 131 may, for example, include the distribution of value in any form, such as the distribution of an ownership stake (including the possibility a fractional ownership stake) in and/or access rights and/or other privileges regarding a digital, physical, or intangible item or entity including but not limited to physical real estate, digital real estate, and/or non-fungible tokens.

The contingent project network 100 may include and/or may communicate with one or more servers in which various forms of value and/or resources may accrue and on which value may be electronically and/or automatically verified. A value storage server 190 for example may hold monetary and/or cryptocurrency value. For example, the value storage server 190 may be operated by a bank and track fiat currency and/or a cryptocurrency exchange and track cryptocurrency or other tokens (e.g., Bitcoin, Ethereum, NFTs). The contingent project object 110 may have an associated account, public key, or other method of designating control over the value.

The digital network server 180 may include a digital network API 182, a profile database 184, and/or a user profile 186. The digital network API 182 may enable direct interaction with the digital network server 180, for example the purchasing and/or trading and/or transferring of assets such as stocks or cryptocurrency, searching for, reading, and/or writing to computer memory content such as social posts, tags, mentions, check-ins, and other digital network information. In one or more embodiments, a digital network transaction 188 may include the purchasing and/or trading and/or transferring of assets, creating one or more social posts, sending a direct message, a 1:1 communication, a 1:n communication (e.g., to an associate of the user profile 186 of a user 102 on the digital network, for example a “friend” of a social media network), a short-form social post (e.g., a Tweet®), a social following, a user profile association (e.g., between two or more instances of the user profile 186), and/or a change of user profile information (e.g., a user profile status, a tagline). In one or more embodiments, a contribution of the contingent project object 110 may include a service contribution 117 that requires a specified instance of a digital network transaction 188. Numerical values and/or qualitative classification values may be assigned to the service contribution 117 and/or the digital network transaction 188 itself, for example as described in conjunction with the embodiment of FIG. 3.

FIG. 1B illustrates a contingent project data structure 115, according to one or more embodiments. The contingent project data structure 115 may include a contingent project object 110, a project constraint data 160, a contingent contribution contract 170, and/or a user object 510B, according to one or more embodiments.

Each of the data entities of FIG. 1B, including the contingent project object 110, may be a data object stored in a computer memory, for example random access memory (RAM), optical memory, magnetic memory (e.g., a hard disk), solid state memory (e.g., a SATA drive), a memristor, and/or another computer readable medium. Each data object, including the contingent project object 110 and/or the contingent contribution contract 170, may be stored according to one or more data models, for example a relational data model, an object oriented data model, a graph data model, a columnar data model, a key-value store, and/or other models.

The contingent project object 110 may include a project UID 111 that may be a unique identifier of the contingent project object 110. The project UID 111 may be a globally unique identifier, and in one or more embodiments may allow for unique addressability within the computer memory and/or a database (e.g., the project database 206). The contingent project object 110 may include a project title 112, for example a string of alphanumeric characters that may be human readable. The contingent project object 110 may include one or more references to user profiles (e.g., the user profile 510) that may own, control, and/or have write access to the contingent project object 110 and/or all or a portion of its data, referred to as the user profile ref 113. The user profile ref 113 may be a data attribute storing a value usable to address the user profile 510 (and/or the user object 510B), for example the user UID 511.

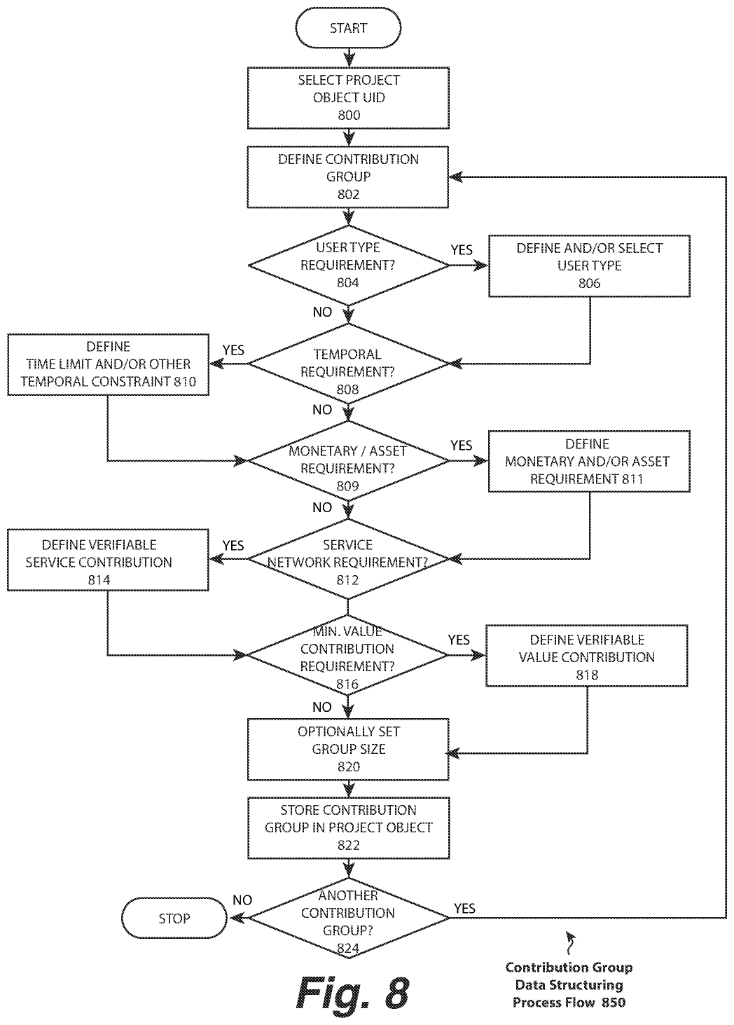

The contingent project object 110 may include one or more contribution conditions. A contribution condition data 114 may be a condition and/or a requirement for contribution to the contingent project object 110. The contribution condition data 114 may include one or more attributes, for example a monetary contribution 116 that may specify a required monetary value in addition to a required, specific currency type (e.g. fiat, cryptocurrency, etc.), an asset contribution 118 such as physical property, digital property, intellectual property, computer processing equipment, etc., and/or a service contribution 117 such as a digital network contribution that may specify one or more required digital network transactions 188 and/or an amount of social influence (as further described in conjunction with the social impact assignment algorithm 302 of FIG. 3) and/or any number of tasks of any type to be accomplished and/or actions to be taken and/or a level of quality of the actions taken and/or an amount of time and/or effort expended, and/or a user type 119 of a required user type for participation (e.g., which may be an attribute and/or value of the user profile 510 or may be otherwise determined at the time of submission of the contribution request 106). As further described in conjunction with FIG. 8, one or more contribution conditions may be set in contribution condition data 114, including for various groups of users 102 (e.g., initializing users 102, a first group of contributors, a second group of contributors, etc.).

The contingent project object 110 may include an initiation condition data 120. The initiation condition data 120 may include an initiation action 121 to be performed, as specified as a value within a data attribute. The initiation action 121, for example, may specify that: value contributed to the contingent project object 110 is to be locked to the project (until, for example, a distribution action 131, as discussed below); a notice of project initiation should be sent to contributors; and/or an excess of resource is returned depending on the amount of a different resource (e.g., returning monetary contributions if enough assets such as digital, physical, or intangible resources, and/or service resources have been contributed and/or enough services have been performed). In another example, the initiation action 121 can include initiating the purchase of stocks, cryptocurrency, one or more non-fungible tokens, or some other asset, whether tangible or intangible, including but not limited to digital or physical real estate or items using the monetary funds and/or other contributions that have been contributed to the contingent project object 110. In another example, the initiation action 121 can include the initiation of an evaluation process using a value assessment engine 305 to determine the extent and/or value of contribution associated with each user profile 510, enabling a followup set of one or more distribution actions 131 resulting in a disbursement to each user profile 510 that is proportionate to the extent and/or value of their contribution. The initiation criteria 122 may specify a criterion and/or criteria that data can be evaluated against to determine whether an initiation condition is met. For example, the initiation criteria 122 may require that a threshold value has been achieved, whether in regards to monetary contributions 116, asset contributions 118, service contributions 117, and/or value of any other kind or combination as may be measured by a value assessment engine 305 through time, effort, group consensus, and/or some other metric or means (e.g. the amount of engagements received through social media posts that reference the project title 112). Specifically, in one or more embodiments, initiation criteria 122 may include a date 123 (e.g., a test for initiation occurs and/or is triggered on a certain date), a monetary contribution requirement 124 (e.g., one hundred thousand dollars to be raised), an asset contribution requirement 129 (e.g. one hundred thousand dollars of current-market value contributed in the form of non-fungible tokens), a service contribution requirement 125 such as a social impact requirement (e.g., four thousand likes on posts on a social media network across at least ten social network profiles, where each post references the project title 112), and/or a user requirement 126 (e.g., at least five percent of the monetary contribution 116 is associated with an expert in a relevant field)). An initiation data source reference 127 may specify a data source for the data to be evaluated against the initiation criteria 122, for example various databases, external sources, and/or stored data of the contingent project object 110 itself. It should be noted that in one or more embodiments one instance of the contingent project object 110 (e.g., a contingent project object 110A) may be dependent on certain actions of a different instance of the contingent project object 110 (e.g., a contingent project object 110B). For example, one project such as building a community shed may be dependent on another project, such as building a community garden. Following initiation, continued contribution may or may not remain open, and/or a different contribution group specified in the contribution condition data 114 may be activated for future contributions.

In one or more embodiments, the contingent project object 110 may include a distribution condition data 130 that may specify one or more conditions for distribution of one or more types of value. In one or more embodiments, the distribution condition data 130 may include a distribution action 131 and the initiation criteria 122 may be stored attributes and/or associated values. The distribution action 131 may be the distribution of a value, for example a monetary value, an equity value, a cryptocurrency, an ownership stake in some kind of digital, physical, and/or intangible asset (e.g. a non-fungible token or set of non-fungible tokens, digital real estate, physical real estate, etc.), access rights and/or privileges regarding an asset which could be digital (e.g. access and/or usage rights to a software platform), physical (e.g. access and/or usage rights to a physical property), or intangible (e.g. usage rights to intellectual property) in nature, and/or a social value that may be automatically and electronically performed. The social value, for example, may occur where the contingent project object 110 and/or one or more user profiles 510 associated with the contingent project object 110 may automatically post a message of gratitude to a social network profile (e.g., an instance of the user profile 186) associated with a different user profile 510 (e.g., an instance of the user 102A that is an initializer of the contingent project object 110 thanking a contributing instance of the user 102X). In another example, the distribution action 131 can include a set of one or more distribution actions 131 resulting in a disbursement to each user profile 510 that is proportionate to the extent and/or value of their contribution as determined through a value assessment engine 305. In one or more embodiments, the distribution condition data 130 may include a distribution ruleset comprising a distribution proportion (e.g., 5% of value, 0.00001% of a value) at least partially dependent on the user type and/or a date of the contribution request of the second user; (iii) a numerical value assigned to the monetary contribution, (iv) a numerical value assigned to the asset contribution (e.g., as may be specified in the asset contribution requirement 129 and its submission tracked in association with the user participant reference 140), and/or (v) a numerical value assigned to the service contribution (e.g., as may be specified in the service contribution requirement 125 and its submission tracked in association with the user participant reference 140).

The distribution condition data 130 may include a distribution criteria 132. The distribution criteria 132 may specify a criterion and/or criteria, stored as data, that can be evaluated against to determine whether a distribution condition is met. For example, the distribution criteria 132 may require that a threshold value has been achieved in association with the contingent project object 110, whether monetary, asset, service, and/or any other type of value as may be determined through a value assessment engine 305. Specifically, in one or more embodiments, distribution criteria 132 may include a date 133 (e.g., on which distribution criteria is tested), and/or a value requirement 134 (e.g., the contingent project object being worth one million dollars in value, as may be determined from automatic electronic sources such as valuing stock and/or cryptocurrency holdings). A transaction window 135 may specify a time over which a distribution action 131 may occur, especially where input from one or more users 102 who would otherwise receive the distribution is required (e.g., a permissive withdraw of value). A user type 136 may be data specifying a type of the user profile 510 (e.g., as determined from data of the user profile 510 and/or classification of the user profile 510) to which the distribution action 131 may apply. In one or more embodiments, the user type 136 may specify a user group. In one or more embodiments, the user group may be a subset of the plurality of users 102 (e.g., as may be specified in the contribution condition data 120) based on at least one of a user type 119, a contribution type contributed by the subset of the plurality of users 102, a length of association with the contingent project object 110 (e.g., one day, one month, a number of interactions or transactions with the contingent project object 110), and/or a random group (e.g., a random group selected from one or more instances of the contribution condition data 120 set up for a set of one or more groups).

A distribution data source reference 137 may specify a data source for the data to be evaluated against the distribution criteria 132, for example various databases, external sources, and/or stored data of the contingent project object 110 itself. It should be noted that in one or more embodiments, one instance of the contingent project object 110 (e.g., a contingent project object 110A) may be dependent on one or more actions of one or more different instances of the contingent project object 110 (e.g., a contingent project object 110B). For example, a distribution action 131 associated with one contingent project object 110A may depend on an initiation action 121B and/or a distribution action 131B occurring in association with another contingent project object 110B.

A contract reference 156 may be a data attribute storing a value usable to address a contingent contribution contract 170, as further described below. The contingent project object 110 may include a database reference to one or more participants, for example initializers such as founds, contributors, and/or other beneficiaries. The user participant reference 140 may be drawn to a user profile 510, including an instance of the user profile 510 shown in FIG. 1B (e.g., the user object 510B, as further described below). Associated with the user participant reference 140 may be a distribution reference 141, a numerical value 142 of a contribution, a qualitative classification of a contribution (e.g., qualitative classification value stored in a computer memory), a type of contribution (e.g., monetary, service, asset, other), a quantity 143 of a contribution, a user type 144 associated with a user profile 510 referenced by the user participant reference 140, and/or a social value of a contribution (e.g., as assigned a value and stored). A distribution reference 141 may include a reference to a distribution condition data 130 (e.g., associating a user profile 510 with a distribution condition data 130). For example, one instance of a distribution condition data 130 (e.g., a distribution condition data 130A) may generally specify a distribution action 131A and a distribution criteria 132A for an initializing user (e.g., the user 102A of FIG. 1A), whereas a different distribution condition data 130 (e.g., a distribution condition data 130B) may generally specify a different distribution action 131B and a different distribution criteria 132B associated with a contributing instance of the user 102 (e.g., the user 102X of FIG. 1A).

A numerical value 142 and/or a qualitative classification may be a value assigned to a monetary contribution 116, asset contribution 118, and/or service contribution 117 of a user 102 and/or assigned to a monetary, asset, or service transaction, for example by the value assessment engine 305 as further shown and described in conjunction with the embodiment of FIG. 3. For example, a service contribution 117 may involve a digital network contribution such as a social network contribution of a user 102, in which a numerical value 142 or qualitative classification value may be assigned to said contribution or to an associated digital network transaction 188 such as a social network transaction as further shown and described in FIG. 3.

A quantity 143 may specify an amount of monetary value and/or cryptocurrency contributed by a user profile 510 referenced by the user participant reference 140, for example in dollars, Bitcoin, Ethereum®, or other currencies and/or cryptocurrencies. Note that a total quantity of value and/or a total numerical value may be determined for the contingent project object 110 by summing each instance stored in association with each of the user participant reference 140, and/or may be individually tracked in an attribute and value pair of the contingent project object 110 and/or in an external database. A user type 136 may be a classification of a user profile 510 referenced by the user participant reference 140.

In one or more embodiments, the contingent project object 110 may include a governance ruleset 150 that may include a set of data for specifying and/or defining controls over read and/or write access of the contingent project object 110 and its data. In one or more embodiments, the governance ruleset 150 may include a user profile reference 151 to a user profile 510 (and/or the user object 510B) that may have an associated governance right 152. The governance right 152, for example, might be a voting right (e.g., one vote per one Bitcoin, two votes per social post with 500 likes in the last 3 months as may be electronically determined, three votes per each hour of effort expended as may be electronically determined, etc.). Although not shown, the governance ruleset 150 may specify governance rights 152 by class of user, by user type, and/or through individual reference to user profiles 510. The governance ruleset 150 may be used to hold votes and/or other proceeds to change the contingent project object 110, including for example modifying the initiation condition data 120, the distribution condition data 130, unwinding the contingent project object 110 (e.g., which may occur in association with terminating the project), etc.

In one or more embodiments, the contingent project object 110 may include an economic ruleset 153. The economic ruleset may similarly specify a user profile reference 154 applying an economic right to an instance of the user profile 510. For example, in one or more embodiments the economic ruleset 153 may include a distribution proportion 155 such that several instances of the user profile 510 within a similar distribution group (e.g., referencing the same distribution condition data 130) may receive different amounts (e.g., a distribution in proportion to a contribution, including for example a mixture of the numerical value 142 and/or the quantity 143 and/or a qualitative classification value). The qualitative classification value, for example, may be a type of contribution, whether the contribution meets a threshold requirement, a level of quality of a contribution as may be assessed and/or assigned by a user and/or individual, etc.

In one or more embodiments, the contingent project data structure 115 may include a project constraint data 160. The project constraint data 160 may include a set of stored data that may be automatically generated to describe all or a subset of the contingent project object 110 and/or its data. In one or more embodiments, the project constraint data 160 may include a project reference 162 which may be an attribute storing a data value usable to uniquely address the contingent project object 110, a project title 112 (e.g., extracted from the contingent project object 110), a contribution description 163 that may describe in human readable form each instance of the contribution condition data 114, an initiation description 164 that may describe in human-readable form one or more instances of the initiation condition data 120, and/or a distribution description 166 that may describe in human-readable form one or more instances of the distribution condition data 130. The project constraint data 160 may also include descriptions of the participants and/or associated instances of the user profile 510 (and/or one or more groups of users, such as the initializers), the governance ruleset 150, and/or the economic ruleset 153. In one or more embodiments, the project constraint data 160 may be automatically generated from the contingent project object 110. This may be useful where the contingent project object 110 is defined and/or stored as code in a self-executing data object and/or data object with self-executing properties (e.g., a “smart” contract), for example as further shown and described in the embodiment of FIG. 6. The self-executing properties, for example, may include the automatic initialization and distribution based at least in part upon automatically generated data input and/or not requiring immediate human input or verification in order to output initialization and/or distribution processes.

In one or more embodiments, a contingent contribution contract 170 may be a data object that may be utilized to indirectly associate a quantity 143 with the contingent project object 110. For example, in one or more embodiments the contingent contribution contract 170 may be a self-executing data object (e.g., “smart contract”) that may or may not lock value in association with the contingent project object 110 until certain conditions occur (e.g., the initiation action 121). In one or more embodiments, a user 102 may choose whether to contribute to a contingent project object 110 through a direct transfer of value to an account associated with and/or controlled by the contingent project object 110 (e.g., a bank account, a cryptocurrency public key), and/or whether to specify a contingent contribution contract 170. As used herein, a cryptocurrency public key that may appear in a DLT database (whether or not that database is a “public” ledger or is accessible by the public) may also be referred to as a cryptocurrency public address.

The user contribution condition 174 may include data specifying under what conditions self-execution will lead to the contribution of the value, and/or whether the contingent contribution contract 170 is cancelable or upon what conditions. In one or more embodiments, the initiation criteria 122 may include, for example, that a threshold total quantity of value across multiple instances of the contingent contribution contract 170 is reached (e.g., summing each instance of the quantity 143).

A user distribution condition 177 may specify a condition for returning value to the user profile 510 of the user 102, for example where initialization does not occur on or before a date 178.

In one or more embodiments, a user profile 510 may be stored independently of the contingent project data structure 115, for example in a profile database 508. In one or more other embodiments, the user profile 510 may be stored as part of the contingent project data structure 115, where each instance of a user 102 may be represented by a user object (shown as the user object 510B). The user object 510B may include any data of the user profile 510, but in FIG. 1B is illustrated with a user UID 511 that allows the user object 510B to be uniquely addressed within a database, a value 520 (e.g., a cryptocurrency and/or monetary value owned or controlled by the user object 510B), a contract reference 521 to one or more contingent contribution contracts 170, and/or a social profile reference 516 to one or more instances of the social network profile (e.g., an instance of the user profile 186) associated with the user 102. The user object 510B may also store a reference to any instance of the contingent project object 110 to which the user object 510B has made a contribution, which may form a two-way reference between the contingent project object 110 and the user object 510B.

Where the contingent project object 110 is implemented as code in a self-executing contract (e.g., stored on a DLT database), the user object 510B may be an account on a DLT database, including for example a public key with some indicia of a user owner/controller. Alternatively, or in addition, where the contingent project object 110 is implemented as code in a self-executing contract, the user participant reference 140 may be drawn to an external database and/or a different DLT database that may otherwise be unknown to users of the DLT database.

FIG. 2 illustrates the project server 200, according to one or more embodiments. The project server 200 may include a processor 201 that is a computer processor and a memory 203 that is a computer memory (e.g., random access memory, hard disk memory, solid state memory). The project server 200 may be communicatively coupled over the network 101, through which it may receive an initialization request 104 for initialization of a contingent project object 110. The initialization request 104, for example, may include a unique identifier of a user profile 510 associated with a client device 400 generating the initialization request 104 (e.g., a user UID 511), the project title 112, and/or other data of the contingent project object 110. A project initialization routine 202 may comprise a computer application or portion thereof that may set up the contingent project object 110 with initial data, whether in a temporary memory location and/or a database. In one or more embodiments, the project initialization routine 202 comprises computer readable instructions that when executed receive over a network 101 an initialization request 104 from a client device 400 of the first user 102, and may call a database application 205 to set up a data object that will be the contingent project object 110, including for example generating an identifier such as the project title 112.

In one or more embodiments, a project structuring engine 210 may then be utilized to define, add to, and/or write data to the contingent project object 110, including for example by receiving data from applications running on one or more instances of the client device 400. In one or more embodiments, the project structuring engine 210 may include a contribution condition subroutine 212, an initiation condition creation subroutine 214, an initiation data source designation subroutine 216, a distribution condition generation routine 218, a distribution data source designation subroutine 220, and/or a project governance engine 222.

The project structuring engine 210 may comprise computer readable instructions that when executed generate a contingent project object 110 (e.g., in a project database 206) comprising a unique identifier of the contingent project object 110 (e.g., the project UID 111) that may be a computer readable string, a project title 112 that may be human readable, and a first referential attribute referencing the user profile 510 of a first user 102 (e.g., a first user 102 generating the initialization request 104). The project UID 111 may be automatically assigned by a database application, for example through a GUID algorithm.

In one or more embodiments, the contribution condition subroutine 212 may comprise computer readable instructions that when executed define a contribution condition data 114 for a plurality of users 102 (e.g., as may be open to any user profile 510, or as may be specified by a user type 119 of a user profile 510) to contribute to the contingent project object 110, the contribution condition data 114 comprising a monetary contribution 116 (e.g., as specified in a monetary contribution requirement 124), an asset contribution 118 (e.g. as specified in an asset contribution requirement 129), and/or a service contribution 117 (e.g. as specified in a service contribution requirement 125), each of which may be electronically verifiable.

In one or more embodiments, the monetary contribution 116, asset contribution 118, and/or service contribution 117 may be electronically verifiable. For example, a service contribution 117 may be a social media contribution that may include verifiable “likes” (e.g., in which a user of the social media network adds an emoji or other indicator in response to a message), mentions (including use of “@” or “#” to designate a tag or other identifier), friend requests, and/or other actions drawing attention to, marketing, and/or promoting the project associated with contingent project object 110. Continuing with this example, the social media contribution may include receiving data through a first API (e.g., the digital network API 182) evidencing transmission of a message to a social media server, where the message references the contingent project object 110 (e.g., by the project title 112, by the project UID 111) and/or references a user profile 186 (e.g., a social media profile) associated with a user profile 510 of one of the plurality of users 102. In another example, the service contribution 117 may include verifiable time spent carrying out some activity such as digital activity (e.g. playing an online video game) or some means of verifying quality and/or effort (e.g. crafting a certain number of items in an online video game, building and/or modifying one or more digital objects within some digital context resulting in a contribution that is evaluated and accepted by the other users which may occur at least in part through the use of a value assessment engine 305, etc.) associated with the contingent project object 110.

In one or more embodiments, the initiation condition creation subroutine 214 includes a software application or portion thereof that defines an initiation condition, for example defining the initiation condition data 120 and causing it to be stored and/or associated with the contingent project object 110. In one or more embodiments the initiation condition creation subroutine 214 comprises computer readable instructions that when executed define an initiation condition data 120 comprising an initiation action 121 and an initiation criteria 122. The initiation action 121 may be self-executing upon a determination by an initiation evaluation routine (e.g., the initiation evaluation routine 322 of FIG. 3) that the initiation criteria 122 has been met. The initiation data source designation subroutine 216 may be a software application or portion thereof that receives a selection and/or selects, and then stores, data designating one or more data sources usable for determining whether initiation should occur.

In one or more embodiments, the initiation data source designation subroutine 216 comprises computer readable instructions that when executed select an initiation data source (e.g., the initiation data source 329) comprising and/or outputting an initiation data 328 necessary, as a first input to the initiation evaluation routine 322, to the evaluation of whether the initiation criteria 122 has been met. The initiation data source 329 may include at least one data stored in and/or in association with the contingent project object 110, and/or may include a second API to an external data source accessible over the network 101. For example, the initiation data source 329 may specify a total number of user participant references 140 stored in the contingent project object 110, or a sum of each of their quantity 143 of value. As another example, the initiation data source 329 may call an external API such as that provided by an enterprise (e.g., FedEx®), where initiation occurs when evaluation of data queried through the external API determines the initiation criteria 122 has been met (e.g., delivery of lab equipment required to set up a laboratory and therefore begin a timeline for a research project). The initiation data source 329 also may be selected from other instances of the contingent project object 110 that may model other projects, for example instances also stored within the project database 206. Therefore, in one or more embodiments, a data structure may include a set of two or more contingent project objects 110 that may include dependencies, including interdependent requirements for contribution, initiation, and/or distribution. In one or more embodiments, a hierarchy of events may be defined in a data structure of two or more instances of the contingent project object 110.

In one or more embodiments, a distribution condition generation routine 218 may include a software application or portion thereof that generates a distribution condition (e.g., as may be stored as the distribution condition data 130). In one or more embodiments, the distribution condition generation routine 218 includes computer readable instructions that when executed define a distribution condition data 130 comprising a distribution action 131 and a distribution criteria 132, where the distribution action 131 may be self-executing upon a determination (e.g., by a distribution evaluation routine 332) that the distribution criteria 132 has been met. In one or more embodiments, there may be more than one distribution condition data 130. For example, each instance of the distribution condition data 130 may be associated with a different user group and/or user type 136, and/or may trigger at different times (e.g., as may be specified in the date 133 of each). The distribution condition generation routine 218 may similarly receive selections for a transaction window 135 and/or a user type 136 from a client device 400 (e.g., by a user 102 initializing and/or setting up the contingent project object 110).

In one or more embodiments, a distribution data source designation subroutine 220 may include a software application or portion thereof that may receive a selection of and/or select a data source that may be stored and/or can submit data sufficient to determine whether a distribution criteria 132 has been met. In one or more embodiments, the distribution data source designation subroutine 220 includes computer readable instructions that when executed select and/or receive a selection of a distribution data source 339 as an input to the distribution evaluation routine 332, where the distribution data source 339 may include and/or may be able to generate a distribution data 338 that is necessary to the evaluation of whether the distribution criteria 132 has been met. For example, the distribution data source 339 may be an external API to a cryptocurrency exchange with realtime value for price of a cryptocurrency in dollars, and where the distribution criteria 132 is the contingent project object 110 controlling enough cryptocurrency in dollar value to permit a limited withdraw by one or more participating instances of the user 102 and/or the client device 400 of the user 102.

In one or more embodiments, the project server 200 may include a priority structuring module 204, a distribution constraint routine 208, and/or a constraint description engine 207. In one or more embodiments, the priority structuring module 204 may include a software application and/or portion thereof that may set a priority for distribution among one or more instances of the user profile 510, user groups of user profiles 510, and/or user types (e.g., as may be specified in the user type 136).

In one or more embodiments, the priority structuring module 204 may include computer readable instructions that when executed constrain a distribution condition (e.g., as may be specified in a distribution condition data 130) that a distribution action 131 is only performed upon completion of a different distribution action 131. For example, a first distribution condition data 130A may be required to complete a first distribution action 131A prior to the execution of a second distribution action 131B of a second distribution condition data 130B. As just one example, the first distribution action 131A may be associated with a user type 136A that is a “contributor” and the second distribution action 131B may be associated with a user type 136B that is an “initializer” and/or a “founder” of the contingent project object 110, such that there is an assurance that outside contributors may receive distribution of value or other benefit first. In one or more embodiments, the priority structuring module 204 may store data specifying the priority in one of any number of ways, including, for example: specifying in the distribution criteria 132, specifying in association with the user participant reference 140 (e.g., with the distribution reference 141), specifying in the economic ruleset 153, requiring associations of certain user types 136 with certain distribution condition data 130, and/or storing data specifying the priority in other attributes and/or associated values of the contingent project object 110. In one or more embodiments, the distribution constraint routine 208 may comprise a software application or portion thereof that may actively constrain initializers and/or founders (e.g., the user 102A through the user 102B) by ensuring a correct association with lower priority instances of the distribution condition data 130. In one or more embodiments, the distribution constraint routine 208 comprises computer readable instructions that when executed disallow association of the user profile 510 of a user of the user 102 (e.g., the user 102A) with a first distribution condition data 130A (e.g., a distribution condition data 130A with a user type 136 of “contributor”) and/or un-associate a unique identifier of the user profile 510 (e.g., through the distribution reference 141 of the user participant reference 140) with the first distribution condition data 130A. Rather, such initializing instances of the user 102 may be constrained to an association between the user profile 510 and a second distribution condition data 130B (e.g., via the distribution reference 141).

In one or more embodiments, the contingent project object 110 may be a stored data object written in software code, abbreviated machine readable data, database code, markup language, and/or a smart-contract coding language, each of which may or may not be easily read and interpreted by users 102. Therefore, In one or more embodiments, an automatic extraction of data and translation into a more human readable form may be effected. In one or more embodiments, the constraint description engine 207 may generate a project constraint data 160 automatically from the contingent project object 110. In one or more embodiments, the project constraint data 160 may, for example, extract the project UID 111 and store the project UID 111 as a value of the project reference 162, may extract and store the project title 112, and/or may extract other important identifying information. In one or more embodiments, the constraint description engine 207 may, for example, extract from the contingent project object 110 and apply one or more transformations to generate narrative and/or summarizations of various aspects of the contingent project object 110, especially for each instance of the contribution condition data 114, the initiation condition data 120, the distribution condition data 130, the governance ruleset 150, and/or the economic ruleset 153. In one or more embodiments, the constraint description engine 207 may include computer readable instructions that when executed may generate a project constraint data 160 comprising the project title 112, an initiation description 164 of the initiation criteria 122 automatically translated from the initiation criteria 122, and a distribution description 166 of the each of one or more distribution criteria 132 (e.g., a first distribution criteria 132A of a first distribution condition data 130, a second distribution criteria 132B of a second distribution condition data 130B, etc.) automatically translated from each such instance of the distribution criteria 132. Similarly, a contribution description 163 may also be generated for the contribution condition data 114. For example, the distribution action 131 may store data specifying in code that fifty percent of all value gain of a cryptocurrency over a two week period prior to a date 133 may be distributed, if such gain exists, and the distribution description 166 may automatically translate the code (including any coded if, then, else statements, coded contingencies, and/or specified data sources) into narrative form. This may also be useful in such case that the contingent project object 110 is a self-executing contract written in a smart contract coding language. Optionally, one or more initializers (e.g., the user 102A) may review and correct the distribution description 166. Also as an option, in one or more embodiments, any participating user 102 or some subset of participating users 102 may be able to contribute to editing one or more elements of a project description and/or project constraint data 160, including the contribution description 163, the initiation description 164, the distribution description 166, and/or a governance ruleset description, such that quality control can occur through a Wikipedia-style editing system that can be open-sourced and/or community moderated. In one or more embodiments, the constraint description engine 207 may include computer readable instructions that when executed transmit the project constraint data 160 to a server computer (e.g., the project server 200) accessible by one or more of the plurality of users 102 (e.g., via the client device 400 over the network 101) to describe participation constraints of the self-executing properties of the contingent project object 110. For example, the project constraint data 160 may be usable to post to social media profiles representing and/or associated with the project and/or contingent project object 110.

FIG. 3 illustrates a condition server 300, according to one or more embodiments. The condition server 300 can include a processor 301 that is a computer processor and a memory 303 that is a computer memory. In one or more embodiments, the condition server 300 may include a contribution engine 310, an initiation engine 320, and/or a distribution engine 330. The condition server 300 may also include a value assessment engine 305 that may, in some cases, utilize a social impact assignment algorithm 302 and a random number generator 304 that may utilize an entropy source 306. The condition server 300 may be connected to the network 101, including to a contribution data source 319, an initiation data source 329, a transaction system 342, and/or a distribution data source 339.

In one or more embodiments, the contribution engine 310 may be a software application or portion thereof that accepts or rejects a contribution asserted by a user 102. In one or more embodiments, the contribution engine 310 may be a software application or portion thereof that accepts or rejects a contribution or electronic evidence thereof submitted by a client device 400, for example a contribution submitted to the contingent project object 110 (e.g., acceptance and/or rejection of a contribution request 106 or portion thereof generated by the client device 400X of the user 102X). In one more embodiments, the contribution engine 310 may determine an acceptance or a rejection of a contribution request 106 based at least in part on a determination produced by a value assessment engine 305 as to whether or not the contribution request 106 meets a minimum requirements, for example specified in the contribution condition data 120, monetary contribution 116, service contribution 117, and/or asset contribution 118. In one or more embodiments, the contribution engine 310 may comprise a contribution receipt agent 312, a contribution evaluation routine 314, and/or a subscription routine 316.

The contribution receipt agent 312 may detect and/or receive a contribution request 106 generated by a client device 400 and may call one or more other software and/or hardware systems, for example the contribution evaluation routine 314. In one or more embodiments, the contribution receipt agent 312 includes computer readable instructions that when executed receive a contribution request 106 from a user 102 (e.g., the user 102X) of the plurality of users (e.g., the user 102X through the user 102Y) to contribute a monetary contribution 116, an asset contribution, and/or a service contribution 117 to the contingent project object 110. The contribution request 106 may include a unique identifier of a user profile 510 associated with the client device 400 and/or the user 102 (e.g., the user UID 511), a unique identifier of the contingent project object 110 that may be the target of the contribution request 106, and/or data specifying the asserted contribution.

In one or more embodiments, the contribution evaluation routine 314 may include a software application or portion thereof that evaluates the sufficiency of the contribution by a user 102, a client device 400, and/or a user profile 510. The contribution evaluation routine 314 may receive a contribution data 318 comprising data usable to determine whether the contribution condition specified in the contribution condition data 114 has been satisfied, for example evidence of a service contribution 117 such as social impact achieved through a social network transaction (e.g., an instance of the digital network transaction 188), a monetary transaction, an asset transaction, data from the user profile 510, and/or other data. In one or more embodiments, the contribution evaluation routine 314 may compare an asserted contribution against preexisting criteria to determine the contribution (and/or the user profile 510) qualifies for and/or has specified a sufficient contribution to contribute to and/or become associated with the contingent project object 110 (e.g. through the use of a value assessment engine 305). In one or more embodiments, the contribution evaluation routine 314 may comprise computer readable instructions that when executed determines the contribution condition has been met. In one or more embodiments, the contribution evaluation routine 314 may comprise computer readable instructions that when executed compares an asserted contribution associated with a user profile 510 to a contribution criteria that may be stored in the contingent project object 110, for example a monetary contribution 116, an asset contribution 118, and/or a service contribution 117. Other criteria may also be evaluated, for example whether the user profile 510 is associated with a certain user type 119. As just one example, certain classes of user 102 and/or user profile 510 may be provided certain different contribution conditions that may be defined in the contribution condition data 114, for example associated with a different user group. A first period of time may have a first contribution condition data 114 (e.g., the first two weeks after the contingent project object 110 may receive contributions), and a second period of time may have a second contribution condition data 114 (e.g., after the first two weeks but before the expiration of eight weeks from a date of formation of the contingent project object 110). It should be noted that in one or more embodiments a series of contributions may be required to meet the contribution criteria. For example, the user profile 510 may first have to contribute by providing a service, the completion of which may be electronically verifiable such as providing social influence, building an object within a digital framework, and/or providing expert information (e.g., meeting the service contribution 117) and then, as the next step, may be required to submit a monetary value (e.g., the monetary contribution 116). In one or more embodiments, there may be an enforced order to contribution, with possible electronic verification following each step.

In one or more embodiments, an asset contribution 118 and/or a service contribution 117 may be assigned a numerical value and/or a qualitative classification value, which may be used to determine whether an asset contribution requirement 129 and/or service contribution requirement 125 have been met (e.g., numerical value 142). In one or more embodiments, a value assessment engine 305 may be used to assign a numerical value and/or a qualitative classification value to the asset or service contribution 117. For example, in the case of a service contribution 117 involving the provision of social influence through the use of a digital social network, the value assessment engine 305 may comprise a software application or portion thereof that can assign a numerical value 142 and/or a qualitative classification value to a digital network transaction 188 of a user profile 186 associated with a user profile 510. In one or more embodiments, the asset contribution 118 and/or service contribution 117 may be a qualifying instance of an asset transaction or service transaction, respectively. In one or more embodiments, wherein the asset contribution 118 and/or service contribution 117 involves a digital network (e.g. a stock trading platform such as Charles Schwab, a social network such as Facebook, etc.), said contributions may be evaluated by automatically generating a call to the associated network server (including without limitation using information provided in the contribution request 106 and/or information within the user profile 510), either through a URL or via the network API, to detect, determine, and/or parse the asset transaction and/or service transaction. For example, a service contribution 117 may require that an associated social network profile of a user 102 post a general message on the primary landing page of the social network profile, or that an associated digital gaming profile of a user 102 spends a certain amount of time leveling up a digital character or crafting digital items within a video game network, or that the user 102 accomplishes any number and/or type of task within a metaverse network such as building digital real estate. In another example, an asset contribution 118 may require that the user profile 186 of a user 102 has dedicated sufficient computer processing resources to a network. In some embodiments, to meet criteria, the action(s) may need to associate with the contingent project object 110 in some electronically verifiable way (such as through a message that includes the project title 112 of the contingent project object 110 as an alphanumeric string, or by electronically verifying that the user profile 186 or network resource belongs to the owner of the user profile 510), and/or there may be other requirements imposed upon the user profile 186 carrying out the action such as requiring that the network profile on a social network (e.g. an instance of the user profile 186) may need at least two hundred friends, followers, and/or other qualifying contacts, or that user profile 186 in a video game involves a character that meets certain criteria (e.g. a sufficient character level). This qualifying information may be determined and/or electronically verified through calls to the network API, through scraping of web pages, image recognition of submitted screenshots (e.g., submitted by the user 102 in the contribution request 106), through screen analysis of single page applications and/or other apps displaying information from the network server, and/or through a digital peer review process. As just one example of concurrent use of the value assessment engine 305, the user profile 510 asserting a qualifying service contribution 117 that is a social network contribution may need to receive a score of at least five “points”, where two points are awarded for a public post, one point is awarded to a 1:1 personal communication, and three points are assigned where the social network profile (e.g., an instance of the user profile 186) associated with the user profile 510 has at least five thousand friends, followers, and/or other profile associations. Further examples of concurrent use of the value assessment engine 305 include: the user profile 510 asserting an asset contribution 118 that is the provision of computer processing power, wherein the more processing power that is provided, the greater value the user is determined to have contributed via the value assessment engine 305 (for example, the value assessment engine may determine a numerical value and/or a qualitative classification value that is assigned to the contribution which may be a representation of the processing power provided, e.g., an absolute value in MHz, a proportional value that is a comparison to the computer processing power that has been contributed by other user profiles 510, etc.); the user profile 510 asserting an asset contribution 118 that is the transfer of ownership of non-fungible tokens, wherein the value assessment engine 305 may analyze public market data in order to produce a numerical value in USD to quantify the value of the contribution associated with the user profile 510; the user profile 510 asserting a service contribution 117 that is that is the accomplishment of one or more tasks described in human readable format by the contingent project object 110, wherein a value assessment engine 305 may be used to quantify and/or qualify the value of the task completion by accounting for the time it took to complete said one or more tasks, the effort it took to complete said one or more tasks, and/or the level of priority of the one or more tasks that were completed in comparison to other tasks requested by the contingent project object 110 wherein said priority may have been determined upon creation of the contingent project object 110 and/or may be a determination that occurs dynamically based upon a consensus process that queries other user profiles 510 to determine the priority hierarchy, and/or implementing a peer review system that may query other users or persons to produce a consensus determination of the value (which may be described in USD; as a ranking relative to other tasks; through any number of ways that involve quantification in some capacity including universal quantification, existential quantification, etc.; and/or through qualification as opposed or in addition to said quantification, etc.) of the completion of said one or more tasks. Note that, in the lattermost of the immediately aforementioned examples, some sort of additional determination system, such as an additional peer review determination system, may also be used to determine whether or not a task that has been asserted by the user profile 510 as being completed was actually completed. In one or more embodiments, it should be noted that the user profile 186 and/or the user profile 510 may be integrated. For example, it will be apparent to one skilled in the art that the contingent project network 100 may be operated as a technology in support of an online network, possibly even by an enterprise owning and/or operating the online network. Also, although FIG. 1A only shows one instance of the digital network server 180, it will be appreciated that multiple instances of the digital network server 180 may be in communication, including from different services (e.g., Facebook®, Meta®, Instagram®, an asset purchasing, selling, or trading network such as Charles Schwab, an online video game, simulation, or digital world, etc.), may be required, called, and/or evaluated.

The subscription routine 316 may comprise a software application or portion thereof that subscribes the user 102 and/or the user profile 510 to the contingent project object 110, for example by forming a database association between the contingent project object 110 and/or the user profile 510. In one or more embodiments, the subscription routine 316 may include computer readable instructions that when executed store a unique identifier of a user profile 510 (e.g., the user UID 511) of a user 102 in a referential attribute (e.g., the user participant reference 140 of the contingent project object 110), and/or associates the unique identifier of the user profile 510 of the user 102 with a distribution condition data 130. For example, in one or more embodiments, meeting different instances of the contribution condition data 114 may associate the user profile 510 with different instances of the distribution condition data 130 (e.g., a first distribution condition applied to a user profile 510 having a lower overall value contribution, whereas a second distribution condition applied to a user profile 510 having a higher overall value contribution).

In one or more embodiments, the initiation engine 320 may include a software application or portion thereof that may determine whether an initiation action 121 should be taken by evaluating data from one or more sources. For example, an initiation data source 329 may be specified for receipt of initiation data 328 to be compared against an initiation criteria 122. The initiation data 328 may be an input selected from an initiation data source 329 which may or may not be external to the condition server 300 and/or the project server 200. For example, the initiation criteria 122 may specify required actions from third parties, or other required world events available via API. For example, where the project modeled by the contingent project object 110 may relate to construction or farming, initiation may depend on the existence of certain weather events within a geographical region as may be available through third-party weather APIs (e.g., a government API such as the NOAA API offered by National Oceanic and Atmospheric Administration). In one or more embodiments, the initiation engine 320 may include an initiation evaluation routine 322 and a contribution return engine 324.

In one or more embodiments, the initiation evaluation routine 322 may include a software application or portion thereof that determines whether the contingent project object 110 should be initiated, e.g., whether certain automated actions effecting the project should begin and optionally whether user profiles 510 associated with the contingent project object 110 should be notified that the project modeled by the contingent project object 110 has begun. In one or more embodiments, the initiation evaluation routine 322 includes computer readable instructions that when executed determine the initiation criteria 122 has been met

In one or more embodiments, the initiation evaluation routine 322 includes computer readable instructions that when executed determine the initiation criteria 122 has not been met, and may generate notification to that effect translated to one or more client devices 400 and/or call the contribution return engine 324 that may return contributions (e.g. monetary contributions 116, asset contributions 118, and/or service contributions 117) to the user profiles 510 who contributed them. It should be noted that, despite what may be the failure of a contingent project object 110 to initiate, it is also possible to “return” some type of value to all contributing users, including those who provided service contributions 117, by automatically sending some type of digital reward such as generating an automatic electronic message thanking a user 102 for contributing to the project, providing some type of user status or ranking upgrade which may grant the user special rights or privileges when participating in followup contingent project objects 110, returning a proportion of the total monetary contributions 116 and/or asset contributions 118 associated with the contingent project object 110 to the user profiles 510 who provided contributions of any and all types (which may distribute in a manner proportional to the determined value of said contributions, including service contributions 117, as may have been described in the contingent project object 110 as a term of providing a monetary contribution 116 and/or asset contribution 118), etc. In one or more embodiments, the initiation evaluation routine 322 may include computer readable instructions that when executed compare the initiation data 328 from an initiation data source 329 to an initiation criteria 122. For example, the initiation criteria 122 may require a certain value specified in a monetary contribution requirement 124, as may be additive of monetary contributions 116, an asset contributions 118, and/or a service contributions 117 (e.g. as determined through a value assessment engine), and/or a user requirement 126 (e.g., a threshold number of associated user profiles 510 having certain listed and/or verified skills and/or social influence). The initiation criteria 122 may also require one or more such requirements and/or thresholds to be met within a timeframe (e.g., by the date 133). Further examples of initiation criteria 122 include but are not limited to manual determination which may be achieved through querying one or more people (such as user profiles 510 who successfully provided a contribution) who have been given the necessary authority by the contingent project object 110 (as may have been determined upon creation of the contingent project object 110, or through other means established by the contingent project object 110 such as voting by user profiles 510 to elect said authority figures, etc.) to trigger initiation through manual decision, which may be achieved by a voting process in the case of said authority being provided to a group of users; the occurrence of some real-world event (e.g. upon the occurrence of a specific piece of federal legislation successfully being passed by the United States Congress) as may be determined through electronic means, whether automatic or manual; entirely at random, as may be described in human readable format in the contingent project object 110; any combination of the aforementioned criteria (e.g. a scenario in which, upon the occurrence of $500M in monetary contributions 116 having been acquired by the contingent project object 110, all contributing user profiles 510 are then queried at random or regular intervals to determine whether or not the project should initiate); etc.

In one or more embodiments, the contribution return engine 324 includes computer readable instructions that when executed return the monetary contribution 116 to each of the plurality of users 102 who had contributed. For example, the contribution return engine 324 may generate a transaction request 340, e.g., initiation a monetary transaction 194 that may include a fiat currency transfer and/or cryptocurrency transfer, that may be sent to a transaction system 192 such as may be operated by a bank and/or a node server 600 storing a distributed ledger. In the context of self-executing contracts (e.g., “smart contracts”), the contingent project object 110 may initiate a distributed ledger transaction (e.g., similar to the transaction 624 of FIG. 6) to transfer contributions (e.g. cryptocurrency, non-fungible tokens, etc.) from the contingent project object 110 to a different data object controlled by each instance of the user 102 (including, without limitation, to a public address that may be a public encryption key owned and/or controlled by the user 102 and/or associated with the user profile 510).

A distribution engine 330 may include a software application or portion of a software application that determines whether a distribution of value is to occur to one or more user profiles 510 associated with the contingent project object 110 and/or effects a distribution action 131. The distribution action 131, for example, may include generating a transaction request 340 to transfer value to one or more contributors (e.g. fiat currency, cryptocurrency, non-fungible tokens, an ownership stake and/or access, usage, or other right or privilege to any kind of physical, digital, and/or intangible asset or service, etc.), and/or generation of a social network transaction (e.g., an instance of the digital network transaction 188) that may provide social value to one or more contributors. In one or more embodiments, the distribution evaluation routine 332 includes computer readable instructions that when executed compares a distribution data 338 from a distribution data source 339 against a distribution criteria 132. The distribution data 338, may include, for example, data relating to a total value (e.g., monetary or numerically assigned value as may be assigned through a value assessment engine 305) of the contingent project object 110, the number and/or type of user profiles 510 associated with the contingent project object 110, a time, a date, and/or data from third-party APIs. An example of a distribution criteria 132 includes a value of an asset (e.g., an amount of cryptocurrency, a number of shares of stock controlled by the contingent project object 110) hitting a certain value (e.g., 200% of its initial purchase price at the time of the initiation action 121, which may have included purchasing the asset). Another example of the distribution criteria 132 may be one or more initializers of the contingent project object 110 (e.g., the user 102A through the user 102B) shipping a product developed with one or more instances of the monetary contribution 116 to ninety percent of contributors (in such case, the distribution data 338 may require manual data entry and/or an automatic query to a user profile 510 associated with each of the initializers). Further examples of distribution criteria include but are not limited to: manual determination which may be achieved through querying one or more people (such as user profiles 510 who successfully provided a contribution) who have been given the necessary authority by the contingent project object 110 (as may have been determined upon creation of the contingent project object 110, or through other means established by the contingent project object 110 such as voting by user profiles 510 to elect said authority figures, etc.) to trigger distribution through manual decision, which may be achieved by a voting process in the case of said authority being provided to a group of users; the occurrence of some real-world event (e.g. upon the occurrence of a specific piece of federal legislation successfully being passed by the United States Congress) as may be determined through electronic means; entirely at random, as may be described in human readable format in the contingent project object 110; any combination of the aforementioned criteria (e.g. a scenario in which, upon the occurrence of the value of an asset having appreciated by 20%, all contributing user profiles 510 are then queried automatically to determine whether or not the distribution action 131 should occur); etc.

In one or more embodiments, the distribution action 131 may be to automatically transfer a value to a user 102, and/or may allow for permissive “withdraw” of the value by the user 102. Therefore, in one or more embodiments, the distribution authorization routine 334 may include computer readable instructions that when executed may generate a distribution notice 108 and/or enable processing of a distribution request from the client device 400 and/or the user 102. In one or more embodiments, there may be a transaction window 135 over which the distribution request may be processed.

In one or more embodiments, the distribution evaluation routine 332 may include computer readable instructions that when executed may determine that the distribution criteria 132 has been met and then initiate a distribution action 131 such as a transaction window 135 (e.g., five minutes, one week) enabling a user 102 to initiate a distributed ledger transaction 624 transferring a cryptocurrency and/or an electronic token out of the control of the contingent project object 110 (and/or canceling contingent contribution contract 170).

In one or more embodiments, one instance of the distribution data 338 may be a random number, for example generated by a random number generator 304 that may also be an instance of and/or included within the distribution data source 339. The random number generator 304 may generate a random number and/or a random string or other data that may be usable as an input to determine at random whether a distribution action 131 should be taken. For example, where there may be multiple contribution and/or distribution groups defined (each such group may have a 1% chance on any given day of the year that they will be subject to a distribution action 131 of the contingent project object 110). The random number generator 304 may include an entropy source 306 (e.g., processor heat signatures, thermal noise, audible sound noise gathered by a microphone, keystroke and/or mouse movement, mobile phone screen interactions, quantum randomness, etc.). The requirement for a random determination may also be placed in combination with other requirements. For example, before a certain instance of the date 133 there may be a 0.5% chance per day of a distribution action 131 occurring, whereas after the date 133 there may be a 2% chance per day, provided that a value requirement 134 has been maintained.

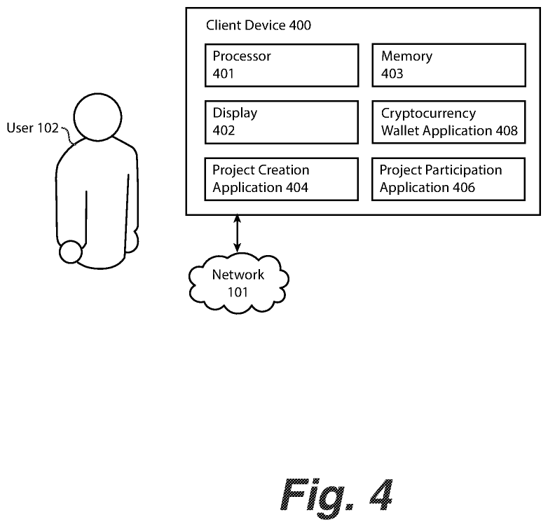

FIG. 4 illustrates a client device 400, according to one or more embodiments. The client device 400 may include a processor 401 that is a computer processor and a memory 403 that is a computer memory. The client device 400 may include a display 402 (e.g., an LCD, an OLED screen, a monitor). In one or more embodiments, the client device 400 may include a project creation application 404, a project participation application 406, and/or a cryptocurrency wallet application 408. The client device 400 may be connected to the network 101 through a network interface controller. In one or more embodiments, the client device 400 may be a mobile device, a smartphone, a tablet computer, a laptop computer, a PC, a server computer acting in a client capacity for communication with the other servers of the contingent project network 100, and/or another computing system.

In one or more embodiments, the client device 400 may include a project creation application 404. The project creation application 404 may enable the user 102 to initialize the project and the contingent project object 110, including for example generating the initialization request 104 and submitting information and instructions to the project structuring engine 210 to further structure the contingent project object 110, for example as further shown and described in conjunction with FIG. 2. Similarly, the project participation application 406 may permit the users to generate contribution requests (e.g., the contribution request 106) and receive notifications related to the contingent project object 110 (e.g., a distribution notice 108), and/or receive distributions. The client device 400 may further include a cryptocurrency wallet application 408 as known in the art, which may store and/or manage private encryption keys controlling cryptocurrency, tokens, and/or smart contracts (including private keys paired with public keys usable as public addresses on the DLT network). The cryptocurrency wallet application 408 may be linked with and/or permitted to exchange some amount of controlled information with the project participation application 406 (e.g., for automatic generation of an instance of the transaction 624), according to one or more embodiments. The project creation application 404, the project participation application 406, and/or the cryptocurrency wallet application 408 may be integrated into a single application, or multiple applications, and a user interface (UI) for each as may be presented on the display 402. The client device 400 may also include financial software applications (e.g., an app allowing banking transactions, Venmo®, etc.).

FIG. 5 illustrates a user profile server 500, according to one or more embodiments. The user profile server 500 may include a processor 501 that is a computer processor and a memory 503 that is a computer memory. A query engine 504 may be a computer application or portion thereof (e.g., a feature of a commercial database application, such as MongoDB®, Neo4J®, Oracle®) that may be used to query a profile database 508, for example in response to a call from the project server 200 and/or the condition server 300. An authentication system 506 may include a software application or portion thereof that authenticates a user 102 and/or a client device 400 that may attempt to act on behalf of and/or assert control over a user profile 510. The authentication system 506 may include soft specifying authentication in two or more authentication factors (e.g., something the user 102 knows such as a password, something the user 102 has in possession, such as a specific instance of the client device 400 and/or a fob, and/or something the user 102 “is” such as a biometric). The authentication system 506 may also use third party authentication protocols (e.g., via OAuth). In one or more embodiments, the user 102 and/or the client device 400 may undergo authentication prior to or in association with a contribution, distribution, and/or withdraw.

The profile database 508 may be a collection of data that includes one or more user profiles 510. The user profile 510 may include a user UID 511 (e.g., a GUID, a random alphanumeric string, an email address checked and/or enforced for uniqueness within the profile database 508, etc.). The user profile 510 may include a user name 512 (e.g., a real name, a handle), and a user data 513 (e.g., demographic data, location data, address, and other similar information). In one or more embodiments, the user profile 510 may store a set of associated profiles 514, including for example a financial profile through a financial profile reference 515 and/or a social network profile through a social profile reference 516. In one or more embodiments, the user profile 510 may store a set of associated projects 518, for example a database attribute that is a project reference 519A through a project reference 519B. For example, the user profile 510 may have acted as an initializer or “founder” of a contingent project object 110A referenced by the project reference 519A, and the user profile 510 may have acted as a contributor to a contingent project object 110 referenced by the project reference 519B. In one or more embodiments, the user profile 510 may further include a value 520 that may specify a total amount of value associated with the user profile 510, and/or a contract reference 521 that may specify a contingent contribution contract 170 owned and/or controlled by the user 102.

FIG. 6 illustrates a distributed ledger and/or blockchain implementation 601, according to one or more embodiments. In one or more embodiments, and the embodiment of FIG. 6, the contingent project object 110 may be defined as a self-executing contract 610, for example a “smart contract” stored in a block 620 of a distributed ledger technology database. The distributed ledger technology database (i.e., “DLT database”) may be a distributed file (e.g., the Bitcoin blockchain file, the Ethereum blockchain file, a private blockchain file made via Hyperledger, etc.) reconciled across a set of node servers (e.g., the node server 600A through the node server 600N) through a consensus mechanism (e.g., “proof of work”, “proof of stake”, Byzantine fault tolerance).

The self-executing contract 610 may be continuously and/or periodically evaluated by each instance of a node server 600 within a distributed ledger technology network 605 (shown as the DLT network 605), including evaluations of contributions, initiations, and/or distributions. For example, the contribution data source 319 may include: the DLT database may act as the contribution data source 319 (e.g., enabling a measurement of whether enough instances of the user 102 have contributed monetarily, and how much), act as the initiation data source 329 (e.g., enabling a measurement of whether enough instances of the user 102 and/or unique public keys have contributed to the contingent project object 110 to trigger initiation, per the initiation criteria 122), act as the transaction system 192 (e.g., sending a cryptocurrency transaction from cryptocurrency owned by the self-executing contract 610 to a public key and/or self-executing contract owned by a user 102), and/or the distribution data source 339. It should be noted that data sources for various evaluations of the self-executing contract 610 need not be internal to the self-executing contract 610 and/or DLT database, but can also reference external APIs (including APIs of the social media network server, the value storage server 190 of a bank, and/or other external sources). In one or more embodiments, the initiation data source 329 may include a different smart contract or other addressable distributed application on the DLT network 605 (e.g., DApp), for example a distributed autonomous organization (DAO) which may output certain results arriving at a consensus about certain world facts (e.g., weather, price, location, etc.).

In one or more embodiments, a user 102 may contribute a cryptocurrency and/or electronic token to the contingent project object 110 through the DLT network 605. For example, the block 620(N−1) may store the self-executing contract 610 which was initialized by a first user (e.g., the user 102A). In a later block, for example the block 620N, a contributing user (e.g., the user 102X) may transfer value to the self-executing contract 610 by initiating a transaction 624 transferring value from a user public key 626 to a contract public key 628. Note that, in one or more embodiments, the contract public key 628 may act as the unique identifier of the contingent project object 110 (e.g., the project UID 111) within the DLT database.

In one or more embodiments, a contract engine 604, which may be running on a computing device (e.g., the project server 200), may include a software application or portion thereof that automatically generates a self-executing contract code 609 that may be transmitted to a node server of the DLT network 605 (e.g., the node server 600A) and incorporated into a block 620. In one or more embodiments, each block 620 may include a block time 621.

In one or more embodiments, the contingent project object 110 is and/or may include a self-executing contract 610 stored in a distributed ledger database on a node server 600 of a distributed ledger technology network 605. A contract public key 611 may act as the project UID 111. In one or more embodiments, the contribution code 612 may be software code stored in the DLT database that is executable by a node server 600 and may implement the contribution condition data 114 and/or the contribution engine 310. In one or more embodiments, the initiation code 613 may be software code stored in the DLT database that is executable by a node server 600 and may implement the initiation condition data 120 and/or the initiation engine 320. In one or more embodiments, the distribution code 614 may be software code stored in the DLT database that is executable by a node server 600 and may implement the distribution condition data 130 and/or the distribution engine 330. The contribution code 612, the initiation code 613, and/or the distribution code 614 may be written in, for example, Solidity and/or Vyper smart contracting computing languages.

In one or more embodiments, the monetary contribution 116 may include: (i) a transfer of a cryptocurrency value into control of the contingent project object 110 (e.g., a transfer from a user public key 626 to the contract public key 628, for example as shown in the example transaction 624), (ii) a transfer of a digital token (such as a non-fungible token) into control of the contingent project object 110 (e.g., also in the form of a transfer from a user public key 626 to the contract public key 628, for example as shown in the example transaction 624), (iii) a first distributed ledger transaction locking the cryptocurrency value in association with the contingent project object 110 (e.g., use of a contingent contribution contract 170 which may also be implemented as a self-executing contract), and/or (iv) a second distributed ledger transaction locking the token value in association with the contingent project object. In one or more embodiments, the initiation criteria 122 may include the contingent project object 110, including for example as implemented as the self-executing contract 610, controlling: (i) a threshold amount of value (e.g. cryptocurrency value, non-fungible token value, etc.) as may be measured in USD, Bitcoin, etc., (ii) a threshold number of digital tokens, (iii) a threshold amount of cryptocurrency value that is locked in association with the contingent project object 110, and (iv) a threshold number of digital tokens that are locked in association with the contingent project object 110.

In one or more embodiments, a contribution request 106 may be included in a distributed ledger transaction. The contribution request 106 may include the unique identifier of the contingent project object 110, for example the contract public key 611 of the self-executing contract 610. The self-executing contract 610 and the initiation code 613 may be used to determine a failure of initiation and automatically re-distribute and/or return cryptocurrency and/or tokens to one or more instances of the user 102.

For example, in one or more embodiments, a determination that a threshold value (e.g., of cryptocurrency) has not been met or exceeded within a threshold time (e.g., in days, or as may be measured in number of blocks 620 which may be known in the art to have an approximate and/or average time length to each block). A return of cryptocurrency and/or digital tokens of any kind (e.g. a non-fungible token) may occur by initiating a transaction from a contract public key 628 back to the user public key 626. Similarly, there may be a release of cryptocurrency value locked in association with the contingent project object 110 and/or the digital token locked in association with the contingent project object 110. In one or more embodiments, the initiation code 613 may therefore additionally implement the contribution return engine 324.

Data internal to the DLT database and/or the DLT network 605 may be used to determine random events, such as the occurrence of distribution events, meeting distribution criteria 132 with a random component, and/or the opening of a transaction window 135 for one or more instances of the user profile 510 and/or groups of users 102. In one or more embodiments, the random number generator 304 may be implemented in part by the distribution code 614, and may be generated at least in part from operation of the distributed ledger technology network 605.

In one or more embodiments, random numbers may be utilized as an input to a set of code and/or an algorithm to determine whether to open a transaction window 135. The random number may be generated by the random number generator 304, which may at least in part utilize a block time 621 of the distributed ledger technology network 605 (which may also be referred to simply as the distributed ledger network 605 herein). In such case, the random time and/or other random data that may occur as a result of application of a consensus mechanism (e.g., solving random cryptographic puzzles to receive a cryptocurrency reward) may be used as the entropy source 306. Also, in one or more embodiments, the governance right 152 (e.g., as shown in the embodiment of FIG. 1B) may include a voting right in proportion to the value of the contribution of a user 102 (e.g. a monetary contribution 116, an asset contribution 118, and/or service contribution 117) as may be determined, whether quantitatively or qualitatively, and/or compared (e.g. ranked relative to other contributions) through a value assessment engine 305. In one or more other embodiments, the DLT client application running on the node server 600 may include a software method and/or a library for generating random values.

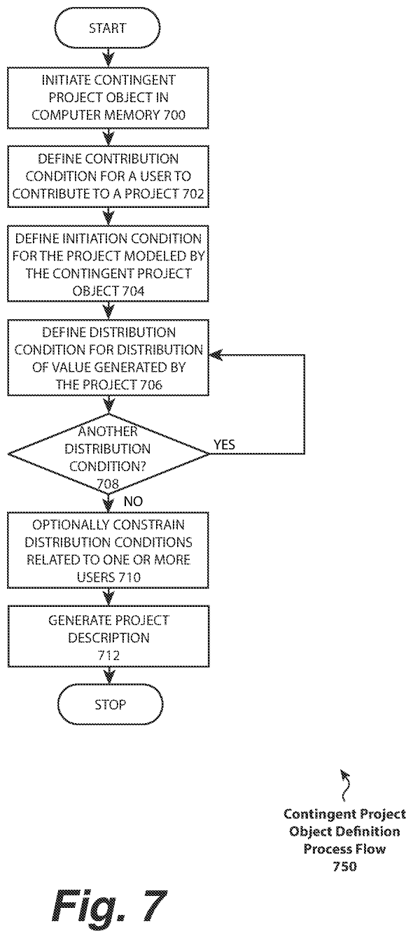

FIG. 7 illustrates a contingent project object definition process flow 750, according to one or more embodiments. Operation 700 may initiate a contingent project object 110 in a computer memory. The contingent project object 110 may be initialized in random access memory and added to and/or modified before storage (e.g., in a solid-state memory and/or magnetic memory). Operation 702 may define a contribution condition for a user 102 to contribute to a project modeled by and/or associated with the contingent project object 110. The contribution condition, such as the contribution condition data 114, may be specified with contingencies, triggers, Boolean operators, and/or additional coding techniques known in the art of software engineering. For example, the contribution condition data 114 may allow the user to submit multiple types of contributions (e.g. a monetary contribution 116, an asset contribution 118, and/or a service contribution 117), where a requirement for one of the contributions (e.g. the value of the monetary contribution 116) may depend on a metric associated with another contribution (e.g. the value of the service contribution 117, such as a social network contribution, as may be determined and/or compared through a value assessment engine 305), and also may depend on how much total value (e.g. as may be determined through a value assessment engine 305) has already been contributed to the contingent project object 110. Operation 704 may define an initiation condition for the project modeled by and/or associated with the contingent project object 110. The initiation condition, for example specified in the initiation condition data 120, may list factors, rules, and/or requirements required for initiation of automatic processes of the continent project object 110 corresponding to beginning of the project. In one or more embodiments, there may also be various tiers, types, and/or outcomes of initialization. For example, a first instance of an initiation condition data 120A may specify a first initiation action 121A for meeting a first initiation criteria 122A, and a second instance of an initiation condition data 120B may specified a second initiation action 121B for meeting a second initiation criteria 122B (which may be set up as mutually exclusive or as able to coexist and/or occur concurrently).

Operation 706 may define a distribution condition for distribution of value generated by the project modeled by and/or associated with the contingent project object 110. As previously described, two or more distribution conditions may be specified, including random distribution actions 131, within a distribution condition data 130. Operation 708 is a condition for determining whether another distribution condition should be set. If another distribution condition should be specified, operation 708 returns to operation 706. If another distribution condition is to be specified, operation 708 may proceed to operation 710. It should be noted that such a loop also may be used to define additional instances of the contribution condition of operation 702 (e.g. a conditional operation 703 looping back to operation 702) and/or to define additional instances of the initiation condition of operation 704 (e.g., a conditional operation 705 looping back to operation 704).

Operation 710 operationally may constrain one or more distribution conditions related to one or more users 102 (and/or user profiles 510 of the users 102). For example, distribution of one or more initializers of the contingent project object 110 may have a priority increased and/or decreased relative to other users 102. Conversely, early contributors (which may or may not include the initializers) may receive more value (e.g. stock, cryptocurrency, an ownership stake in or some sort of right or privilege regarding a digital, physical, or intangible asset, etc.) and/or specialized value (including social automatically generated “rewards” such as acknowledgements of support and/or contribution posted to a social network profile that may be an instance of the user profile 186). Operation 712 may generate a project description that may assist in understanding the contribution, initialization, and/or distribution rules and/or requirements stored within the contingent project object 110, such that it may assist one or more instances of the user 102 in deciding whether to contribute to, and/or otherwise support or form an association with the contingent project object 110. In one or more embodiments, the project description in operation 712 may be automatically generated from code and/or stored data within the data structure of the contingent project object 110.

FIG. 8 illustrates a contribution group data structuring process flow 850, according to one or more embodiments. Operation 800 selects a project object UID (e.g., the project UID 111). The project UID 111 may be used to query the contingent project object 110 in a computer memory and/or the project database 206. Operation 802 may define a contribution group. The contribution group may be defined as data specifying one or more user profiles 510, and/or qualities or attributes of user profiles 510, that may define a group of users. A non-limiting example of such a user group is the first one thousand users 102 to contribute. In one or more embodiments, the contribution group may be defined as a contribution condition data 114 having a user type 119. Operation 804 may determine whether a user type requirement should be specified, for example a qualification by a user type 119. The user type 119 may be determined by data of the user profile 510, and/or self-qualifying information that may be submitted by the associated user 102 (e.g., via a questionnaire, survey, and/or statement integrates into a EULA at the time of contribution and/or processing a contribution request 106). If operation 804 determines a user type requirement should be defined, operation 804 may proceed to operation 806 in which a user type 119 may be selected and/or stored. If no user type is to be specified, operation 804 may proceed to operation 808.

Operation 808 determines whether one or more temporal requirements are to be defined. In such case a temporal requirement is to be defined, operation 808 may proceed to operation 810 which may define a temporal requirement, for example a time limit and/or other temporal constraint. As just one example, the temporal requirement may be that the first contribution group has up to thirty days to contribute to the contingent project object 110, where the time limit may be automatically extended depending on a shape of a contribution curve (e.g., which may be graphed as a value versus time, etc.) of the contribution submission over time throughout the thirty day period. Operation 809 determines whether or not there is a requirement for a monetary contribution 116 (e.g. a certain quantity of Bitcoin or fiat currency) and/or a requirement for an asset contribution 118 (e.g. a certain quantity of precious material such as gold or silver, a legal deed to a physical property, ownership of intellectual property, etc.). If there is a requirement for either, Operation 811 may be used to define the monetary contribution 116 and/or the asset contribution 118. Operation 812 determines whether there is a service contribution 117 requirement, for example for a social network contribution such as social media posts, messages, and other possible social network transactions (e.g., examples of the digital network transactions 188). Operation 814 may then define a verifiable instance service contribution 117 including any information the user 102 and/or the user profile 510 may have to submit for verification (e.g., URLS, profile names or identifiers, a screenshot, etc.). Although not shown, similar verifiable instances for the asset contribution 118 may also be defined, for example during operation 811. In one or more embodiments, a user 102 associated with a user profile 510 may have to prove their control over and/or association with a user profile 186 that is relevant to the asset contribution 118 (e.g. a profile on a stock trading platform) and/or service contribution 117 (e.g. a social media profile), including through use of posting verification codes detectable through web page analysis and/or the digital network API 182. Operation 814 then proceeds to operation 816.

Operation 816 may determine whether a minimum contribution (e.g. in regards to a monetary contribution 116, asset contribution 118, and/or service contribution 117) is required to order for a user 102 and/or a user profile 510 to contribute. In such case that a minimum monetary contribution 116 is required, operation 816 may proceed to operation 818 in which a verifiable minimum contribution may be defined. The verifiable contribution may be able, for example, to be verified as a monetary transaction 194 such as a minimum monetary transfer (e.g. a minimum quantity of fiat currency, cryptocurrency, etc.) into the ownership and/or control of the contingent project object 110. Operation 818 then may proceed to operation 820. Similarly, where no minimum contribution requirement is to be set, operation 816 may proceed to operation 820. Operation 820 operationally sets a group size. For example, a limit on the group size may be specified in the number of user profiles 510, some metric regarding monetary contribution 116 (e.g. total value in USD), some metric regarding asset contribution 118 (e.g. total value in USD), some metric regarding service contribution 117 (e.g. value as may be measured in USD, time, a measure of effort, a qualitative assessment, and/or arbitrarily according to a comparative manual ranking by a pool of users 102, etc. as may be determined through a value assessment engine 305), and/or other factors.

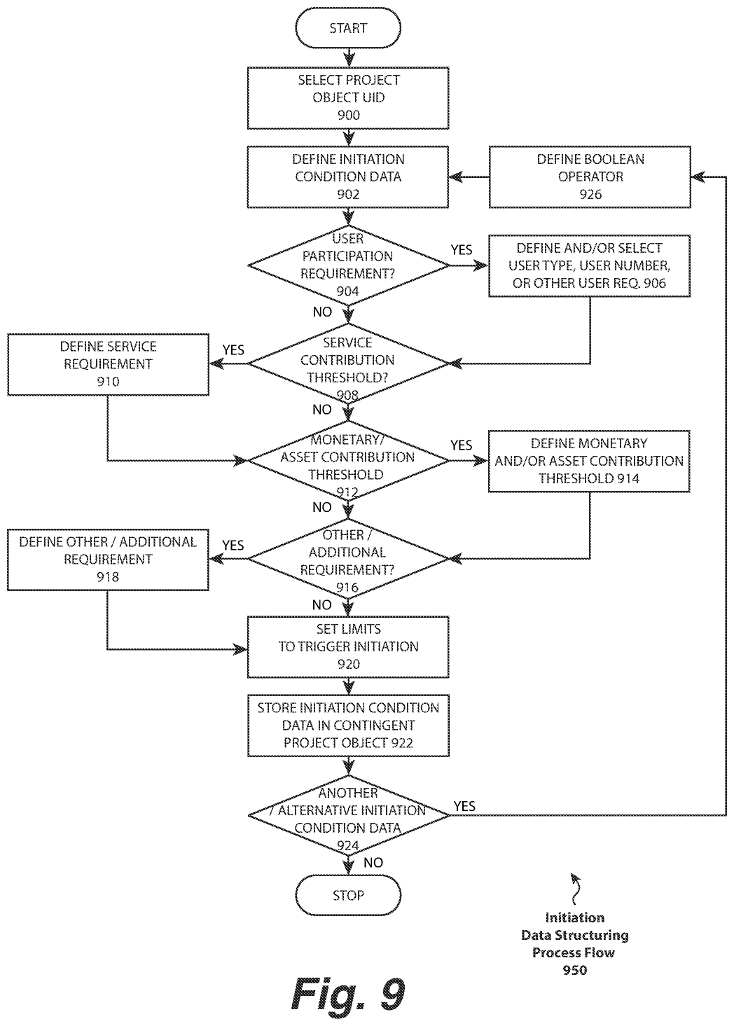

Operation 822 stores the contribution group in association with the contingent project object, for example as a contribution condition data 114 and/or through one or more other methods and/or data locations within the data structure of the contingent project object 110. It should be noted that although the user participant reference 140 in FIG. 1B does not include a reference to the contribution group, the contingent project object 110 may include a reference to the contribution group and/or the contribution condition data 114 that may be used to model the contribution group. Therefore, it will be apparent that associated with a user profile 510 may be both a contribution condition data 114 and/or a distribution condition data 130 (e.g., how a given user 102 and/or type of user 102 is required to contribute, and/or how the contingent project object 110 must distribute back to such user 102). Operation 824 determines whether another contribution group is to be defined. If another contribution group is to be defined, operation 824 returns to operation 802. Otherwise, operation 824 may end and/or proceed to the embodiment of FIG. 9.

It should be noted that certain user groups and/or instances of the contribution condition data 114 may operate concurrently when receiving the contribution request 106. For example, a contributor that may be a strong social influencer having a social network profile (e.g., an instance of the user profile 186) with tens of thousands of followers may qualify for a different instance of a user group and/or therefore have a different instance of the monetary contribution 116, asset contribution 118, and/or service contribution 117. In one or more embodiments, authentication of each user profile 510 may be used to ensure that each instance of the user profile 510 and/or user 102 may sign up with only one contribution group. In one or more other embodiments, a user 102 and/or user profile 510 may sign up for as many contribution groups as they may qualify for.

FIG. 9 illustrates an initiation data structuring process flow, according to one or more embodiments. Operation 900 selects a project UID 111 of a contingent project object 110. Operation 902 defines an initiation condition data 120. Operation 904 is a condition determining whether a user participation requirement should be specified. If a user participation requirement should be specified, operation 904 may proceed to operation 906, which may define and/or select a user type, a number of users, and/or another user requirement. For example, contribution of users 102 and/or user profiles 510 with certain skills, experience, certifications, previous contribution of successful projects, and/or other attributes may be required. Operation 906 may then proceed to operation 908. If no user participation requirement is to be set, operation 906 may also proceed to operation 908. Operation 908 may determine whether a service contribution threshold (such as a social network contribution threshold) should be defined, and, if so, proceeds to operation 910. Operation 910 may define the service requirement, such as a service contribution threshold, for example storing it in a service requirement 125 of the initiation condition data 120. In one or more embodiments the service requirement may be specified in terms of a numerical value, for example the sum of values assigned by a value assessment engine 305 from the contribution of each contributor (e.g., as shown and described in conjunction with the embodiment of FIG. 3) and/or a qualitative classification value that is required as a threshold. Operation 910 may then proceed to operation 912. Similarly, if no service contribution threshold is to be established, operation 908 may proceed to operation 912.

Operation 912 may determine whether a monetary contribution threshold or asset contribution requirement 129 should be defined and/or established. If at least one of said thresholds should be established, operation 912 proceeds to operation 914 in which such a monetary contribution requirement 124 and/or an asset contribution requirement 129 may be defined (e.g., as a monetary contribution requirement 124). The monetary contribution requirement 124 and/or asset contribution requirement 129 may be defined, for example, in fiat currency, cryptocurrency, tokens, other resources or assets, or arbitrarily according to some quantification and/or qualification system (e.g. as may occur through the use of a value assessment engine 305). A collection of value and/or a formula that determines the threshold based on a basket of values may be defined (e.g., one million dollars on a certain date, as determined by the converted value of cash, stock, and cryptocurrency previously contributed). Operation 914 may then proceed to operation 916. Similarly, if no monetary contribution requirement 124 or asset contribution requirement 129 is to be established, operation 912 may proceed to operation 916.

Operation 916 may be used to determine whether any other and/or additional requirements required for initiation should be set, in which case operation 918 may define such other and/or additional requirements. As one example, a different instance of the contingent project object 110 may have to have successfully initiated and/or distributed, for example having triggered one or more initiation actions 121 and/or distribution actions 131. In another example, an additional initiation requirement may include an evaluation and/or conditional referencing one or more inputs pulled from a third-party API, including distributed ledger networks and distributed applications thereof (e.g., an Oracle). Operation 918 may then proceed to operation 920. Similarly, if no other and/or additional requirements are to be specified, operation 916 may proceed to operation 920. Operation 920 may set one or more limits that may prevent and/or delay initiation (e.g., an initiation action 121). For example, just prior to initiation, manual input form one or more initializers (e.g., the users 102A through the user 102B in FIG. 1A) may be required to ensure an affirmed dedication to the project associated with the contingent project object 110, or to certified that certain key events have occurred that are otherwise not able to be determined via an API. In another example, a market price check may be initiated for one or more contributions just prior to initiation, where a dramatic drop or rise in value may cause the initiation action 121 to delay and/or the contingent project object 110 to return contributions to the users 102 and/or unlock contributions dedicated to the contingent project object 110. In yet another example, a limit on triggering initiation may include an evaluation and/or conditional referencing one or more inputs pulled from a third-party API, including distributed ledger networks.

Operation 922 may store the initiation condition data 120 in and/or in association with the contingent project object 110. Operation 924 then may determine whether another and/or an alternate initiation condition data 120 should be specified, in which case operation 924 may proceed to operation 926. Operation 926 may define a Boolean operator, or some other relationship defining the relation between each instance of the initiation condition data 120. For example, in one or more embodiments an “OR” may define an alternative initiation condition data 130, where an “AND” may specify an additional required instance of an initiation criteria 122.

It should be noted that although the process flow of FIG. 9 does not specify an initiation action 121, such an initiation action 121 may be specified in conjunction with one or more instance of the initiation condition data 130 in operation 902, including in an operation 901 (not shown in FIG. 9), and/or in association with each initiation condition data 130, including in an operation 903 (not shown in FIG. 9).

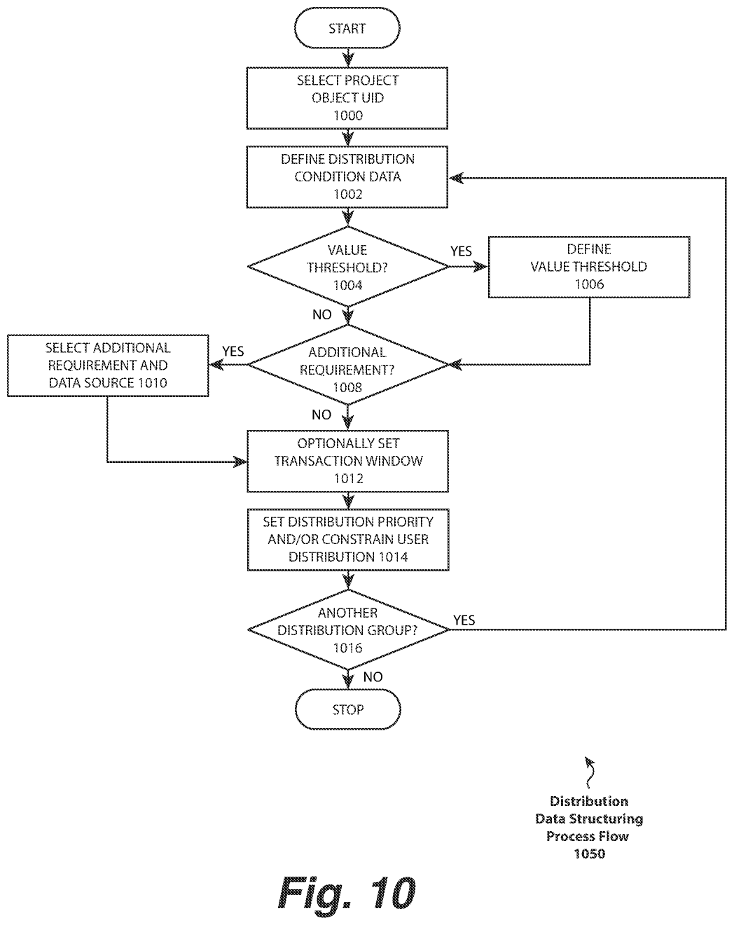

FIG. 10 illustrates a distribution data structuring process flow 1050, according to one or more embodiments. Operation 1000 may select a project object UID (e.g., the project UID 111). Operation 1002 may define a distribution condition data (e.g., the distribution condition data 130). For example, the distribution condition data 130 may be stored in the contingent project object 110 selected in operation 1000. Operation 1004 is a conditional operation that may determine whether a value threshold has to be achieved (e.g., as part of the distribution criteria 132) in order to trigger a distribution action 131. If a value threshold is to be defined, operation 1004 may proceed to operation 1006 that may define a value threshold (e.g., a value requirement 134) that may have to occur over some time period (e.g., the last 30 days, the last 24 hours, at a single test moment). Operation 1006 may be used to store the value requirement 134. It should be noted that any type of value or criteria may be defined and/or measured in any number of ways (e.g. a social impact criteria measured in number of views and/or engagements on one or more social media platforms), although not shown in the embodiment of FIG. 10. In addition, a date 133 or other trigger event may be set for testing whether the distribution criteria 132 should be tested. For example, a test for the distribution condition data 130 may occur as a result of an initiation action 121 occurring in another contingent project object 110, and/or as a result of something from an external data source (e.g., a certain weather pattern that may indicate the beginning of a harvest season). Operation 1006 then proceeds to operation 1008. Operation 1008 may also be arrived at from operation 1004 in the event that operation 1004 does not set a value threshold.

Operation 1008 may determine whether one or more additional requirements should be set (e.g., an additional aspect of the distribution criteria 132). Operation 1010 may then select the additional requirement and an associated data source (e.g., an instance of the distribution data source 339). For example, certain types of users 102 and/or user profiles 510 are still associated with the contingent project object 110, certain other assets (cryptocurrencies, stocks) are at a certain price, and/or that certain other actions of other contingent project objects 110 have occurred. In another example, an additional requirement may include an evaluation and/or conditional referencing one or more inputs pulled from a third-party API, including distributed ledger networks. Operation 1010, and operation 1008 (if no additional requirement is to be specified) both may proceed to operation 1012. Operation 1012 optionally sets a transaction window (e.g., the transaction window 135), and additionally may set whether a distribution is forced and/or permissive. For example, a forced distribution may automatically initiate a transaction (e.g., a monetary transaction 194) to distribute money (e.g. a monetary distribution which may be fiat currency, cryptocurrency, etc.) to a user profile 510, whereas a permissive distribution may await a request from the user profile 510.

Operation 1014 may set a distribution priority (e.g., for the distribution condition data 130 relative to other instances of the distribution condition data 130, such as via a numerical score), and/or may constrain distribution to a user 102 (e.g., by user type 136, by individual user 102 and/or user profile 510). In one or more embodiments, certain user profiles 510 may be constrained to have an association with only certain instances of the distribution condition data 130. Operation 1016 may then determine whether another distribution group and/or distribution condition data 130 is to be defined, in which case operation 1016 may return to operation 1002. Otherwise, operation 1016 may end.

It can be noted that the distribution condition data 130 may be used for various purposes, including setting up different distribution groups, and/or defining separate distribution actions 131 and/or distribution criteria 132 that may be defined relative to one another with Boolean operators (e.g., similar to operation 926 of FIG. 9). In one or more embodiments, several instances of the distribution condition data 130 may be specified, for example one that checks each month for a certain distribution criteria 132A for a first contribution group of user profiles 510A but has more stringent distribution criteria 132A and a more limited distribution action 131A, and another instance that checks annually for a different distribution criteria 132B for a second group of user profiles 510B with a more lenient (e.g., easier to meet) distribution criteria 132B and a larger (e.g., higher monetary value, greater ownership stake in some physical and/or digital asset, etc.) distribution action 131B.

The distribution action 131 may be defined before or after operation 1002, and may be linked to one or more distribution condition data 130. For example, the distribution action 131 could be defined in an operation 1001 (not shown), and/or an operation 1003 (not shown). Optionally, a distribution condition data 130 may be associated with one or more user profiles 510 and/or a contribution group, for example through a distribution reference 141.

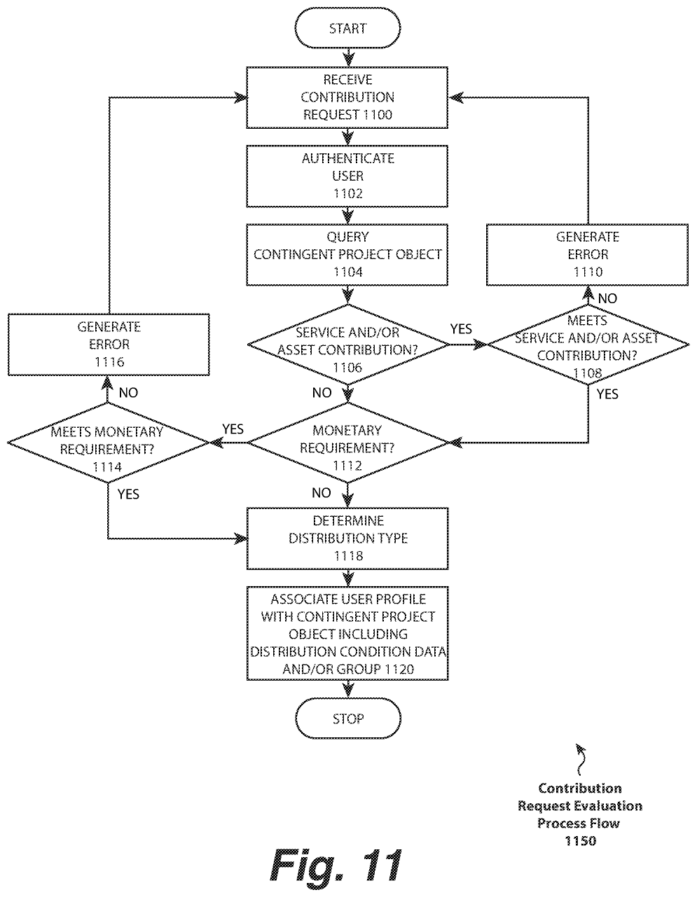

FIG. 11 illustrates a contribution request evaluation process flow 1150, according to one or more embodiments. Operation 1100 may receive a contribution request (e.g., the contribution request 106). The contribution request 106 may be received from a client device 400 over the network 101, including from an initializer of the contingent project object 110 (e.g., the user 102A of FIG. 1A) and/or a later contributor (e.g., the user 102X of FIG. 1A). The contribution request 106 may be generated as a result of a user 102 utilizing the project participation application 406 to review and/or select from a series of available projects in which to contribute to and/or participate in, where selection of the project may include selecting the project UID 111 (whether visible to the user 102 on the display 402 or not) from data stored or available to the project participation application 406. Operation 1102 may authenticate the user 102 and/or the user profile 510. For example, the user 102 may be asked to submit one or more credentials and/or authentication tokens. Operation 1104 may query the contingent project object 110, for example with the project UID 111, which may be included in the contribution request 106.

Operation 1106 may determine whether there is a service contribution 117 and/or an asset contribution 118 that is a requirement for contribution. If a service contribution 117 and/or an asset contribution 118 is determined to be relevant, operation 1106 may proceed to operation 1108 (and otherwise proceeding to operation 1112). Operation 1108 may determine whether a service contribution 117 and/or asset contribution 118 of the user profile 510 has been met, e.g., meets the service contribution requirement 125 and/or asset contribution requirement 129 that may be defined in the contribution condition data 114. Operation 1108 may parse any information sufficient to automatically and/or electronically verify a service contribution 117 and/or asset contribution 118 of a user 102 and/or user profile 510. For example, if the service contribution 117 and/or asset contribution 118 involves the use of a user profile 186, operation 1108 may query the user profile 510 of the user 102 submitting the contribution request 106. Operation 1108 may then test for one or more digital network transactions 188 by visiting webpages associated with each of one or more user profiles 186 (e.g. a social media profile, a profile on a stock trading platform such as Charles Schwab, etc.), by generating queries to the digital network API, and/or through other methods as may be known in the art. In one or more embodiments, one or more other instances of the user 102 may participate in the verification of operation 1108 (e.g. when the service contribution 117 and/or asset contribution 118 requires human assessment to determine its validity and/or quality, such as a service contribution 117 and/or asset contribution 118 that involves designing and submitting feasible architectural plans for a construction project). For example, a user 102A may be sent (on a client device 400A) the contribution data from a contribution request 106 generated by a different user 102B to determine sufficiency of the asserted contribution. In such example, the user 102A may also receive the contribution criteria to be met to determine sufficiency of the asserted contribution. Operation 1108 may further evaluate a numerical value of the service contribution 117 and/or asset contribution 118, for example by assigning a numerical value 142 and/or a qualitative classification value based on a formula and/or algorithm and/or system (e.g., through the use of a value assessment engine 305).

Where the asserted service does not meet the service contribution 117 and/or the asserted asset does not meet the asset contribution 129, operation 1108 may proceed to operation 1110, which may generate an error and then return to operation 1100 (e.g., which may allow the user 102 to attempt again after an appropriate additional attempt). Where the service contribution requirement 125 is met and/or where the asset contribution requirement 129 is met, operation 1108 may proceed to operation 1112.

Operation 1112 may determine whether a monetary requirement (e.g., the monetary contribution requirement 124) has been met, for example for a monetary contribution 116. Where a monetary requirement is applicable, operation 1112 may proceed to operation 1114, which may determine if a value and/or a quantity of money (e.g., the quantity 143) of the user 102 and/or the user profile 510 meets or exceeds the monetary contribution requirement 124. Operation 1114 may determine the sufficiency of the money (e.g. fiat currency, cryptocurrency, etc.) submitted by the user 102 and/or the user profile 510 by assessing a receipt submitted with the contribution request 106, and/or through a call to verify an asserted monetary contribution 116. For example, operation 1114 may generate a call to the value storage server 190. In the event that the value submitted is a cryptocurrency, operation 1114 may generate a query of a blockchain database to determine that value from a public key associated with a user profile 510 (e.g., user public key 626) has been transferred to a public key associated with the contingent project object 110 (e.g., contract public key 628, or another public key controlled by the project). As another example, operation 1114 may query an instance of the value storage server 190 that may be operated by a financial institution to detect a monetary transaction 194 initiated by the user profile 510. Where the monetary requirement is not met, operation 1114 may proceed to operation 1116. Otherwise operation 1116 may proceed to operation 1118.

Operation 1118 may determine a distribution type. For example, the user 102 and/or the user profile 510 submitting the contribution request 106 may be of a type and/or associated with a contribution group such that it should be associated with a certain instance of the distribution condition data 130. Operation 1120 may then associate the user profile 510 with the contingent project object 110 (e.g., through a user participant reference 140) and/or with one or more distribution condition data 130 (e.g., through a distribution reference 141). In addition, a numerical value 142 and/or a qualitative classification value of the monetary contribution 116, asset contribution 118, and/or service contribution 117 of the user 102 and/or the user profile 510 may be stored, the monetary contribution 116 and/or asset contribution 118 may be stored, and/or a user type 144 as may be extracted from the user profile 510 and/or determined and applied in relation to the user 102 and/or user profile 510. For example, where the user data 513 may include a zip code for the user 102 that may be treated as a “type”, the type may also be custom defined and stored in the contingent project object 110. For example, where the zip code of the contingent project object and the zip code of the user profile 510 are within 100 miles, a “local” type may be stored in the user type 144 attribute within the contingent project object 110. Operation 1120 may then end.

It should be noted that an operation not shown may determine which user type that a user profile 510 is classified as, such that which instances of a contribution condition data 114 may be evaluated. For example, a user profile 510 having a certain zip code may be considered to be “local” to a project associated with and/or modeled by the contingent project object 110, and a local instance of the user profile 510 may be evaluated against a specific instance of the contribution condition data 114.

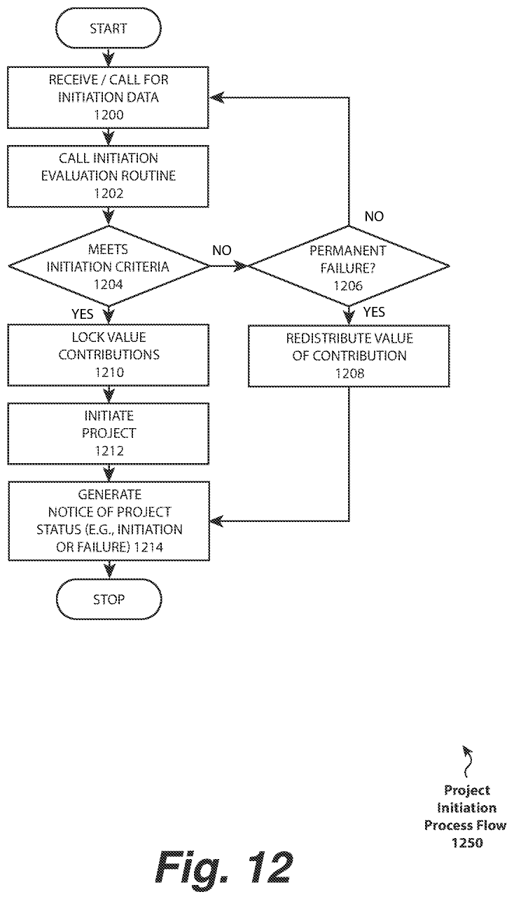

FIG. 12 illustrates a project initiation process flow 1250, according to one or more embodiments. Operation 1200 receives and/or calls for an initiation data 328. The initiation data 328 may be usable to determine whether an initiation criteria 122 has been met. The trigger for the initiation may be a certain event (e.g., occurrence of the date 123, occurrence of a complex set of conditional events that may rely on a certain number of contributors contributing, etc.). The initiation data 328 may be extracted from the continent project object 110 and/or received through a network 101 from an initiation data source 329. Operation 1202 may then call an initiation evaluation routine (e.g., the initiation evaluation routine 322), including with the initiation data and possibly the project UID 111. Operation 1202 may also return the initiation criteria 122 that may be read from a contingent project object 110.

Operation 1204 may compare the initiation data to the initiation criteria 122 to determine if the initiation data 328 meets the initiation criteria 122. Where the initiation criteria 122 is not met, operation 1204 may proceed to operation 1206. Operation 1206 may determine whether a failure to meet the initiation criteria 122 is a permanent failure or a non-permanent failure. If a non-permanent failure, operation 1206 may return to operation 1200 where the initiation condition data 130 may again be received and/or called for, continuously, periodically, or as a result of another trigger event. If the failure is permanent, operation 1206 may proceed to operation 1208 which may redistribute a value of a contribution of one or more users 102 and/or user profiles 510. For example, the plurality of users 102 may each have a quantity 143 of fiat currency and/or cryptocurrency, or one or more assets such as electronic tokens, real estate, etc. transferred back into the ownership and/or control of each such user 102. A “return” of some portion of the value of a service contribution 117 may also be possible, for example providing automated messages and/or acknowledgements as social network transactions (e.g., examples of the digital network transactions 188); distributing monetary or asset contributions back to all contributors in a manner proportionate to the relative value of their contributions, which may occur independently of the type of contribution(s) associated with the users 102, and where only the value of a contribution of a user 102 (e.g. as may have been determined through a value assessment engine 305) may be taken into account for determining the proportion of the total distribution “returned” to each user 102; and/or providing some sort of special right or privilege that may be applicable to participation in other contingent project objects 110; etc. It should be noted that in one or more embodiments, there may be a project initiation for some user groups, but not for others. Thus, one subset of users 102 associated with a first contribution group may move into initiation phase and eventually a distribution phase, whereas a different subset of users 102 associated with a second contribution group may have previously contributed value returned to them.

In some embodiments, the return may involve distribution of some form of money (e.g. cryptocurrency) or assets (e.g. non-fungible tokens) that are independent, separate from, and/or additional to the monetary contributions 116 or service contributions 117 that have been made to the contingent project object 110. For example, while monetary contributions 116 and/or asset contributions 118 may be returned directly to the users 102 who contributed them in the event of a permanent failure to meet the initiation criteria 122, those who made service contributions may have the value of said service contributions “returned” to them in the form of a cryptocurrency that is under the control of or associated with the contingent project object 110 and/or under the control of or associated with a group of users associated with the contingent project object 110. The nature of such a return, including specifications regarding the money (e.g. a cryptocurrency) or asset (e.g. non-fungible electronic tokens) to be distributed in such an event and/or how the value of a service contribution 117 is to be determined (e.g. using a value assessment engine 305 that may be automated and/or may involve a peer review process) may be specified in the description of the contingent project object 110 in a human readable format. In some embodiments, acknowledging understanding of and agreeing to such terms (e.g., as may occur digitally) associated with a contingent project object 110 may be a requirement for participation (e.g., as an initiator, as a contributor).

Where the initiation criteria 122 has been met, operation 1204 may proceed to operation 1210, which may lock the contributions, which may be an example of all or a portion of an initiation action 121. In one or more embodiments, the contributions may be locked by making such contributions non-returnable, except to the extent provided by a distribution action 131. In one or more other embodiments, where a contingent contribution contract 170 is utilized, the locking may occur by causing the distribution of the contingent contribution contract 170 to the contingent project object 110 (e.g., movement from of a public key of the contingent contribution contract 170 on a DLT network to a public key of the contingent project object 110 on the DLT network).

Operation 1212 may initiate the project associated with the contingent project object 110. Operation 1214 may then generate a notice of project status, for example a notice of project initiate and/or of project failure to initiation (e.g., if operation 1214 is arrived at through operation 1208) with respect to one or more instances of the initiation condition data 120. In one or more embodiments, each user 102 and/or user profile 510 may be sent the notice of project status on an associated client device 400.

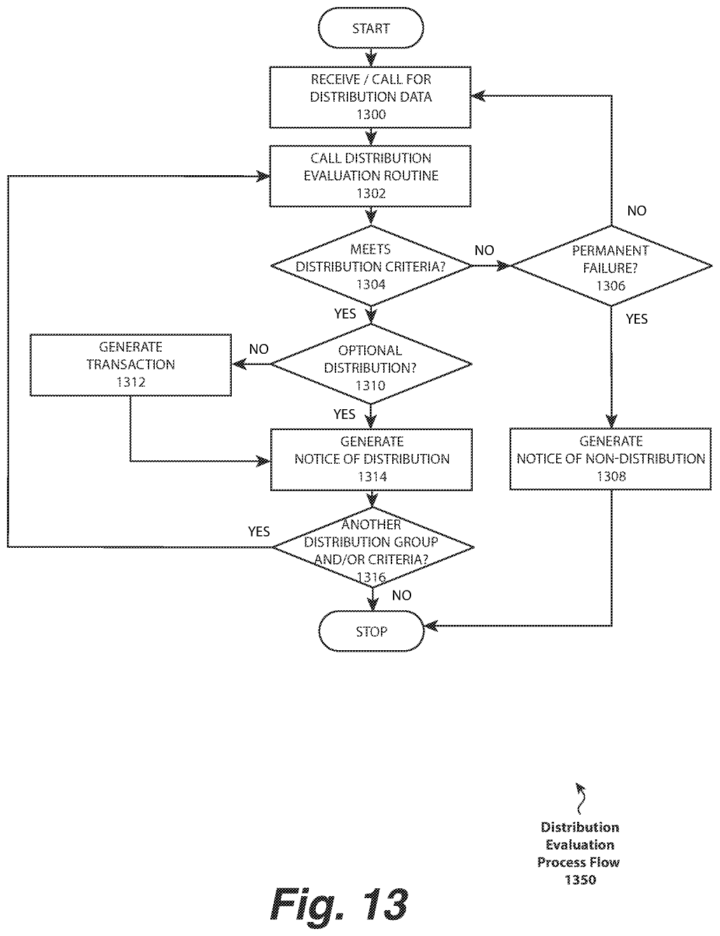

FIG. 13 illustrates a distribution evaluation process flow 1350, according to one or more embodiments. Operation 1300 may receive and/or call for a distribution data 338, for example extracted from the contingent project object 110 and/or received through the network 101 from a distribution data source 339. The trigger for the distribution may be a certain event (e.g., occurrence of the date 133, occurrence of a complex set of conditional events that may rely on a certain number of project milestones being completed as submitted by the initializing users 102, etc.). Operation 1302 may call a distribution evaluation routine (e.g., the distribution evaluation routine 332), including with the distribution data and/or a distribution criteria 132 that may be extracted from a distribution condition data 130. Operation 1304 may determine whether the distribution data 338 (e.g., from the distribution data source 339) meets the distribution criteria 132. Where the distribution criteria 132 has not been met, operation 1304 may proceed to operation 1306 which may determine whether a failure is permanent. If a failure to meet the distribution criteria 132 is permanent, operation 1306 may proceed to operation 1308 which may generate a notice of non-distribution for one or more user profiles 510 associated with the distribution group and/or the distribution condition data 130. In one or more embodiments, a re-distribution of value may also occur, similar to operation 1208 of FIG. 12. Where a failure is not permanent, operation 1306 may return to operation 1300 which may again receive and/or call for a distribution data 338. Where the distribution criteria 132 has been met, operation 1304 may proceed to operation 1310.

Operation 1310 may determine whether a distribution is optional (e.g., permissive) or mandatory. Where not optional, operation 1310 may proceed to operation 1312 which may generate a transaction effecting the distribution. For example, the distribution may be a monetary transaction moving monetary goods to the user 102 and/or the user profile 510, a distribution of transferring or shipping a product or providing a service to a user 102 and/or a user profile 510, and/or any other kind of a transaction including but not limited to an asset transaction, a service transaction, etc. Operation 1312 may be an example of the distribution action 131. The distribution that is triggered may occur automatically and electronically. Operation 1312 may then advance to operation 1314. Similarly, operation 1310 may advance to operation 1314 where the distribution may be optional and/or permissive. Operation 1314 may generate a notice of distribution (e.g., the distribution notice 108) that may be communicated to one or more users 102 and/or user profiles 510, for example that distribution of value has occurred, or that the distribution of value is available upon request. Permissive distribution requests may be received and initiate individual instances of operation 1312 (not shown in the embodiment of FIG. 13). Operation 1316 may determine whether there is another distribution group (as may be modeled by another instance of the distribution condition data 130) and/or additional distribution criteria 132 for evaluation. If an additional distribution group and/or an additional distribution criteria 132 is present, operation 1316 may return to operation 1302. Otherwise, operation 1316 may end.

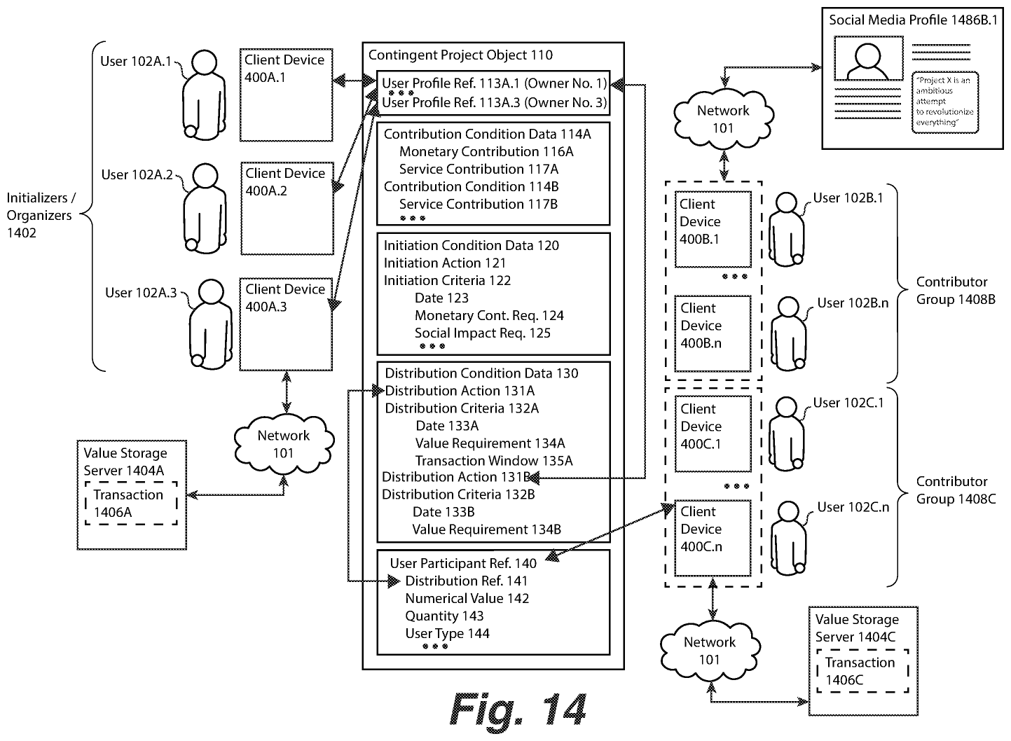

FIG. 14 illustrates an example in which a contingent project object 110 is structured, stored, and evaluated, including constrained distribution parameters of initiating users 102 (e.g., the user 102A.1 through the user 102A.3), defining required monetary contributions 116, asset contributions 118, and/or service contributions 117 according to one or more embodiments.

In the example embodiment of FIG. 14, three users 102A that are initializers may wish to create and/or define a project. In the present example, the project may be the development of a new product. The user 102A.1 may be, for example, a valuable service contributor, such as a social network influencer with a social network profile 186A.1 having thousands of followers, subscribers, and/or other network connections to which the social network influencer may have a preferred communications access, and therefore said user may be capable of making a service contribution 117 that encompasses social influence. The user 102A.2 may be a financial backer, for example who may have a significant amount of monetary value (e.g. fiat currency, cryptocurrency, etc.) available to serve as a monetary contribution 116. And the user 102A.3 may be a valuable asset contributor, such as a product developer with industrial design and engineering experience who can make an asset contribution 118 that may be, for example, product specifications and design plans. Collectively, the user 102A.1 through the user 102A.3 may be referred to as a set of organizers and/or initializers 1402.

One or more of the users 102A may generate an initialization request 104 from a client device 400, and one or more of the users 102A may set up and/or edit the contingent project object 110 utilizing the project creation application 404. The initialization request 104, and continued write requests to the contingent project object 110, may be executed by one or more of the servers of the contingent project network 100 (e.g., the project server 200, the condition server 300, and/or the user profile server 500). The contingent project object 110 may store a user profile reference 113A.1 through the user profile reference 113A.3, for example storing a user UID 511 of each user profile 510 of the initializers 1402.

Two sets of contribution conditions may be defined in two instances of the contribution condition data 114. A first contribution condition data 114A may be set up for a first set of users 102B.1 through the user 102B.n, for example early contributors that may primarily contribute a service contribution 117 such as social influence as carried out through social networking to initially stimulate interest in the project. The contribution condition data 114A may therefore include a service contribution 117. The monetary contribution 116 may be optional, relatively small, and/or open to alternative forms of monetary contribution 116 (e.g., cryptocurrency such as Bitcoin or Ethereum®). The first contribution condition data 114A may be open for a limited time period (e.g., 60 days after a project initialization, but prior to initiation). The contribution condition data 114A may be used to define a contribution group that may be primarily intended to raise awareness, stimulate team growth, and generate some modest operating funds and/or some initial asset purchase funds (e.g., equipment, stock, cryptocurrency). For example, the contribution condition data 114A may be utilized by the contributor group 1408B.

The contribution condition data 114B, in contrast, may be primarily open to those users 102 wishing to monetarily contribute, shown as contributor group 1408C. A period for contribution may open thirty days after initialization.

The initializers 1402 may select and/or define an initiation condition data 120. The initiation action 121 may include locking monetary contributions for example prohibiting withdrawal other than in conjunction with a distribution action 131. The initiation action 121 may also include generating an initiation notification to each user 102 that the project associated with the contingent project object 110 has been initiated.

The initiation criteria 122 may include a date 123 on which a test for a monetary contribution requirement 124, an asset contribution requirement 129, and/or a service contribution requirement 125 may be made. For example, 60 days following initiation, as may be specified in the date 123, there may be a test for total monetary contribution 116, asset contribution 118, service contribution 117, and/or total value (as may be measured by a value assessment engine 305) contributed by all contributor groups 1408. A total monetary contribution requirement 124 may be, for example, one hundred thousand dollars in all monetary value contributed, including fiat currency and/or cryptocurrency. A total service contribution requirement 125 may specify that a task or minimum set of tasks have been completed, or that a minimum goal or set of goals have been accomplished, such as that one million social network profiles have been verifiably exposed to posts, messages, and/or other notifications that may reference the contingent project object 110 or other relevant content linked to the project. Alternatively or in addition, the total asset contribution requirement 129 and/or total service contribution requirement 125 may be based on a numerical point score (e.g. as may be produced through a value assessment engine 305), as shown and described through the present embodiments. For example, the user 102B.1 may be making a service contribution 117 that involves social influence, and said user may have posted on the social network profile 186B.1, where the social media network profile 186B 0.1 includes two hundred followers, and where each follower able to view the post counts as one “point” and each follower who “likes” the post or comments on it counts as ten points. As shown in the example of FIG. 14, the user 102B.1 may have posted to the social network profile 1486.B1 that “Project X is an ambitious attempt to revolutionize everything.”

The initializers 1402 may further define one or more distribution condition data 130. In the present example, a single instance of a distribution condition data 130 is defined with two possible distribution actions 131 (e.g., a distribution action 131A and a distribution action 131B), each with a separate distribution criteria 132 (e.g., a distribution criteria 132A and a distribution criteria 131B). A first distribution action 131A, which may for example distribute a first phase product (e.g., a prototype, a minimum viable product) to each instance of the user 102 contributing, and optionally distribute any unused monetary contributions 116 proportionate to the contribution of the user 102 at an option of each user 102. Where the user 102 opts to receive the unused monetary contributions 116, they may be unassociated with the contingent project object 110 (e.g., opting not to remain a contributor to continued product development). A transaction window 135A may occur for two weeks following the distribution action 131A that may allow for processing of distribution requests.

The distribution action 131B may include distributing a completed product to each contributing instance of the user 102. Part of the distribution criteria 132B may include input from one or more initializers 1402 (e.g., authenticated data input as a source of distribution data source 339) that the product is completed. However, where the product is not yet completed, and a total value requirement 134 for total remaining value (e.g. as may be determined through a value assessment engine 305) is not met, the contingent project object may terminate and the remaining value and/or contributions may be returned and/or distributed to one or more of the users 102. Note that in the present example, the distribution condition data 130 may apply to all possible contributor groups. While in one or more embodiments the initializers 1402 may also receive distributions, in the present example owning the intellectual property of the developed product and/or having received funding for its development may be reward enough for the initializers 1402.

Each user 102 contributing to the project may become associated with the contingent project object 110, for example through a database reference to a user profile 510 of the user 102. The user participant reference 140 may store the user UID 511 of each instance of the user 102 contributing. A distribution reference 141 may associate the user 102 and/or the user profile 510 with one or more distribution condition data 130.

However, in one or more alternative embodiments, more different contribution groups may be associated with different instances of the distribution condition data 130. Referencing an alternate for the present example, early users (e.g., the contributor group 1408B) may have a distribution reference 141A that may be linked to the distribution action 131A, such that there may be an early opportunity to evaluate a prototype before deciding whether to receive a distribution on a proportion of unused monetary contribution 116. The contributor group 1408B may then also have access to the distribution action 131B that may be defined in a different distribution condition data 130B. In contrast, each user 102 of the contributor group 1408C only may include a reference to the distribution action 131B that may be defined in a different distribution condition data 130B. Each user 102 contributing to the contingent project object 110 may have his or her contribution tracked by storing a numerical value 142 and/or qualitative classification value of a monetary contribution 116, an asset contribution 118, and/or a service contribution 117, and/or by noting a relevant instance of a user type 144.

In one or more embodiments, an advantage includes a complex and/or rich data structure that may be defined that may automatically execute one or more critical functions associated with a project. Similarly, a contingent project object 110 can be defined such that automatic technological processes can easily process criteria for contribution, initiation, and distribution associated with the project.

In one or more embodiments, an advantage of the technology, the contingent project object 110, and/or the contingent project data structure 115 includes that a rich and/or complex set of processes may be defined to automatically assess multiple different user types, user groups, contribution groups, initiation conditions, and/or distribution groups that may more readily support evaluating the exact resources needed for the project to be successful. For example, more specific needs can be automatically and rapidly assessed (e.g., evaluating new contribution requests 106 against a requirement that twenty percent of contributors may have a user type of “engineer”, ten percent must have a user type of “attorney”, etc.).

In one or more embodiments, an advantage includes that automatic processes of a data object modeling a real-world project can be constrained such that initializers and/or contributors may have greater certainty as to what will occur as the project unfolds.

In one or more embodiments, an advantage includes that an asset contribution 118 and/or a service contribution 117 to a project can be quantified (e.g., assigned a numerical value) or appropriately qualified (e.g. assigned a classification), electronically verified, and attributed to a user 102, possibly permitting large-scale asset contribution requirement 129 activity and/or service contribution 117 activity (e.g. social media activity) to support a new project. In one or more embodiments, an advantage includes that value in some form can be automatically and electronically “returned” and/or “distributed” to a user profile 510 and/or a user profile 186 (e.g. a social network profile, a profile on a stock trading platform such as Charles Schwab, etc.) associated with a user 102. In one or more embodiments, an advantage includes that monetary contributions 116, asset contributions 118, service contributions 117, and/or any combination of the aforementioned can be evaluated as a contribution for a contributor to a project.

Although some of the advantages have been listed above, many other advantages will be evident to one skilled in the art of software engineering and/or other relevant arts.

Although the present embodiments have been described with reference to specific example embodiments, it will be evident that various modifications and changes may be made to these embodiments without departing from the broader spirit and scope of the various embodiments. For example, the various devices, engines, agent, routines, and modules described herein may be enabled and operated using hardware circuitry (e.g., CMOS based logic circuitry), firmware, software, or any combination of hardware, firmware, and software (e.g., embodied in a non-transitory machine-readable medium). For example, the various electrical structure and methods may be embodied using transistors, logic gates, and electrical circuits (e.g., application specific integrated circuitry (ASIC) and/or Digital Signal Processor (DSP) circuitry).

In addition, it will be appreciated that the various operations, processes, and methods disclosed herein may be embodied in a non-transitory machine-readable medium and/or a machine-accessible medium compatible with a data processing system (e.g., the contingent project network 100, the project server 200, the condition server 300, the client device 400, the user profile server 500, the node server 600, the DLT network 605, the digital network server 180, the value storage server 190, etc.). Accordingly, the specification and drawings are to be regarded in an illustrative rather than a restrictive sense.

The structures in the figures such as the engines, routines, and modules may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the preceding disclosure.

Embodiments of the invention are discussed above with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures.

From reading the present disclosure, other variations and modifications will be apparent to persons skilled in the art. Such variations and modifications may involve equivalent and other features which are already known in the art, and which may be used instead of or in addition to features already described herein.

Although claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any claim and whether or not it mitigates any or all of the same technical problems.

Features which are described in the context of separate embodiments may also be provided in combination in a single embodiment. Conversely, various features which are, for brevity, described in the context of a single embodiment, may also be provided separately or in any suitable sub-combination. The applicants hereby give notice that new claims may be formulated to such features and/or combinations of such features during the prosecution of the present application or of any further application derived therefrom.

References to “one embodiment,” “an embodiment,” “example embodiment,” “various embodiments,” “one or more embodiments,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least one or more embodiments of the invention” includes the stated particular feature, structure, or characteristic.

The enumerated listing of items does not imply that any or all of the items are mutually exclusive, unless expressly specified otherwise.

It is understood that the use of a specific component, device and/or parameter names are for example only and not meant to imply any limitations on the invention. The invention may thus be implemented with different nomenclature and/or terminology utilized to describe the mechanisms, units, structures, components, devices, parameters and/or elements herein, without limitation. Each term utilized herein is to be given its broadest interpretation given the context in which that term is utilized.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; a smartphone, application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, one or more embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The term “processor” may refer to any device or portion of a device that processes electronic data from registers and/or memory to transform that electronic data into other electronic data that may be stored in registers and/or memory. A “computing platform” may comprise one or more processors.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing the contingent project network 100 according to the present invention will be apparent to those skilled in the art. Various aspects of the invention have been described above by way of illustration, and the specific embodiments disclosed are not intended to limit the invention to the particular forms disclosed. The particular implementation of the loyalty rewards programs may vary depending upon the particular context or application. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

Although the present embodiments have been described with reference to specific example embodiments, it will be evident that various modifications and changes may be made to these embodiments without departing from the broader spirit and scope of the various embodiments. For example, the various devices, engines and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., the project server 200, the condition server 300, the client device 400, the user profile server 500). Accordingly, the specification and drawings are to be regarded in an illustrative rather than a restrictive sense.

The structures in the figures such as the engines, routines, and modules may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the preceding disclosure.

What is claimed is:

1. A system for electronic data structuring and management of crowd sourced projects, the system comprising:
a project server comprising:
a processor of the project server,
a memory of the project server,
a project database storing a contingent project object comprising a unique identifier of the contingent project object that is a computer readable string, a project title that is human readable, and a first referential attribute referencing a user profile of a first user,
an initialization routine comprising computer readable instructions that when executed receive a initialization request from a client device the first user,
a project structuring engine comprising computer readable instructions that when executed generate the contingent project object, the project structuring engine further comprising:
a contribution condition subroutine comprising computer readable instructions that when executed define a contribution condition for a plurality of users to contribute to the contingent project object, the contribution condition comprising at least one of a monetary contribution that is electronically verifiable, an asset contribution that is electronically verifiable, and a service contribution that is electronically verifiable,
an initiation condition creation subroutine comprising computer readable instructions that when executed define an initiation condition data comprising an initiation action and an initiation criteria, where the initiation action is self-executing upon a determination by an initiation evaluation routine that the initiation criteria has been met,
an initiation data source designation subroutine comprising computer readable instructions that when executed select an initiation data source comprising an initiation data necessary, as a first input to the initiation evaluation routine, to an evaluation of whether the initiation criteria has been met,
a distribution condition generation routine comprising computer readable instructions that when executed define a first distribution condition data comprising a first distribution action and a first distribution criteria,
wherein the first distribution action is self-executing upon a determination by a distribution evaluation routine that the first distribution criteria has been met, and
a distribution data source designation subroutine comprising computer readable instructions that when executed select a first distribution data source as a second input to the distribution evaluation routine, the first distribution data source comprising a distribution data that is necessary to an evaluation of whether the first distribution criteria has been met; and
a network communicatively coupled to the project server.

2. The system of claim 1, further including:
a condition server comprising:
a processor of the condition server,
a memory of the condition server,
a contribution engine comprising:
a contribution receipt agent comprising computer readable instructions that when executed receive a contribution request from a second user of the plurality of users to contribute at least one of the monetary contribution, the asset contribution, and the service contribution to the contingent project object,
a contribution evaluation routine comprising computer readable instructions that when executed determine the contribution condition has been met, and
a subscription routine comprising computer readable instructions that when executed store a unique identifier of a user profile of the second user in a second referential attribute and associate the unique identifier of the user profile of the second user with the first distribution condition data, and
an initiation engine comprising the initiation evaluation routine, wherein the initiation evaluation routine comprising computer readable instructions that when executed determine the initiation criteria has been met, and
a distribution engine comprising computer readable instructions that when executed determine the first distribution criteria has been met and initiate the first distribution action.

3. The system of claim 2, further comprising
a user profile server communicatively coupled to the network, the client device comprising:
a processor of the user profile server,
a memory of the user profile server,
a profile database storing the user profile of the first user, the user profile of the first user comprising a user UID of the user profile of the first user, a social profile reference, and a project reference, and
an authentication system comprising computer readable instructions that when executed authenticate the first user associated with the user profile of the first user; and
the client device, wherein the client device communicatively coupled to the network and comprises:
a processor of the client device,
a memory of the client device,
a project creation application comprising computer readable instructions that when executed generate the initialization request,
wherein the initialization request comprising the user UID of the user profile of the first user.

4. The system of claim 3,
wherein the condition server further comprising a random number generation routine that generates a random number utilizing an entropy source,
wherein the distribution condition generation routine further comprises computer readable instructions that when executed generate a transaction window defining a third distribution action,
wherein the transaction window initiates the third distribution action at a random time for a subset of the plurality of users,
wherein the subset of the plurality of users is based on at least one of a user type, a contribution type contributed by the subset of the plurality of users, a length of association with the contingent project object, and a random group, and
wherein the distribution evaluation routine further comprising computer readable instructions that when generated initiate the transaction window.

5. The system of claim 4, further comprising:
a node server communicatively coupled to the network and a distributed ledger network,
wherein the contingent project object further comprises a self-executing contract stored in a distributed ledger database on the node server of the distributed ledger network,
wherein the contribution condition specifying at least one of: (i) a transfer of a cryptocurrency value into control of the contingent project object, (ii) a transfer of a digital token into control of the contingent project object, (iii) a first distributed ledger transaction locking the cryptocurrency value in association with the contingent project object, and (iv) a second distributed ledger transaction locking the digital token in association with the contingent project object,
wherein the initiation criteria comprising the contingent project object controlling: (i) a threshold amount of cryptocurrency value, (ii) a threshold number of digital tokens, (iii) a threshold amount of cryptocurrency value that is locked in association with the contingent project object, and (iv) a threshold number of digital tokens that are locked in association with the contingent project object,
wherein the contribution request is included in a third distributed ledger transaction stored on the distributed ledger database comprising the unique identifier of the contingent project object,
wherein a determination that a threshold value has not been met or exceeded within a threshold time comprises generating a fourth distributed ledger transaction effecting at least one of a transfer of at least one of the cryptocurrency value locked in association with the contingent project object and the digital token locked in association with the contingent project object,
wherein the random number generated at least in part from operation of the distributed ledger network, and
wherein the random number generated at least in part by utilizing a block time of the distributed ledger network.

6. A method for generating a data structure supporting constrained participation in crowd sourced projects, the method comprising:
authenticating a first user associated with a user profile of the first user;
receiving over a network a initialization request from a client device the first user;
generating a contingent project object comprising a unique identifier of the contingent project object that is a computer readable string, a project title that is human readable, and a first referential attribute referencing the user profile of the first user;
defining a contribution condition for a plurality of users to contribute to the contingent project object, the contribution condition comprising at least one of a monetary contribution that is electronically verifiable, an asset contribution that is electronically verifiable, and a service contribution that is electronically verifiable;
defining an initiation condition data comprising an initiation action and an initiation criteria, where the initiation action is self-executing upon a determination by an initiation evaluation routine that the initiation criteria has been met;
selecting an initiation data source comprising an initiation data necessary, as a first input to the initiation evaluation routine, to an evaluation of whether the initiation criteria has been met,
wherein the initiation data source comprising at least one of data stored in association with the contingent project object and a first API to an external data source;
defining a first distribution condition data comprising a first distribution action and a first distribution criteria, where the first distribution action is self-executing upon a determination by a distribution evaluation routine that the first distribution criteria has been met; and
selecting a first distribution data source as a second input to the distribution evaluation routine, the first distribution data source comprising a distribution data that is necessary to an evaluation of whether the first distribution criteria has been met.

7. The method of claim 6, further comprising:
generating a project constraint data comprising the project title, an initiation description of the initiation criteria automatically translated from the initiation criteria, and a distribution description of the first distribution criteria automatically translated from the first distribution criteria; and
transmitting the project constraint data to a server computer accessible by one or more of the plurality of users to describe participation constraints of a set of self-executing properties of the contingent project object.

8. The method of claim 7, further comprising:
receiving a contribution request from a second user of the plurality of users to contribute at least one of the monetary contribution, the asset contribution, and the service contribution to the contingent project object;
determining the contribution condition has been met;
storing a unique identifier of a user profile of the second user in a second referential attribute; and
associating the unique identifier of the user profile of the second user with the first distribution condition data.

9. The method of claim 8, further comprising:
defining a second distribution condition data;
constraining the second distribution condition data such that a second distribution action is only performed upon completion of the first distribution action;
at least one of (i) disallowing association of the user profile of the first user with the first distribution condition data, and (ii) un-associating a unique identifier of the user profile of the first user with the first distribution condition data; and
associating the unique identifier of the user profile of the first user with the second distribution condition data.

10. The method of claim 9, further comprising:
determining the initiation criteria has not been met; and
returning at least one of the monetary contribution and the asset contribution to each of the plurality of users and the first user.

11. The method of claim 10, further comprising:
generating a governance ruleset of the contingent project object, the governance ruleset comprising one or more governance rights each associated with at least one of: (i) a user type, and (ii) a unique identifier of the user profile of one of the plurality of users; and
generating a distribution ruleset of the contingent project object, the distribution ruleset comprising a distribution proportion at least partially dependent on at least one of: (i) the user type, (ii) a date of the contribution request of the second user; (iii) a numerical value assigned to the monetary contribution, (iv) a numerical value assigned to the asset contribution, and (v) a numerical value assigned to the service contribution.

12. The method of claim 11, further comprising:
generating a transaction window defining a third distribution action,
wherein the transaction window initiates the third distribution action at a random time for a subset of the plurality of users, and
wherein the subset of the plurality of users is based on at least one of user type, a contribution type contributed by the subset of the plurality of users, a length of association with the contingent project object, and a random group;
generating a random number; and
initiating the transaction window.

13. The method of claim 12,
wherein the contingent project object is a self-executing contract stored in a distributed ledger database on a node server of a distributed ledger network,
wherein the contribution condition specifying at least one of: (i) a transfer of a cryptocurrency value into control of the contingent project object, (ii) a transfer of a digital token into control of the contingent project object, (iii) a first distributed ledger transaction locking the cryptocurrency value in association with the contingent project object, and (iv) a second distributed ledger transaction locking the digital token in association with the contingent project object,
wherein the initiation criteria comprising the contingent project object controlling: (i) a threshold amount of cryptocurrency value, (ii) a threshold number of digital tokens, (iii) a threshold amount of cryptocurrency value that is locked in association with the contingent project object, and (iv) a threshold number of digital tokens that are locked in association with the contingent project object,
wherein the contribution request is included in a third distributed ledger transaction stored on the distributed ledger database comprising the unique identifier of the contingent project object,
wherein a determination that a threshold value has not been met or exceeded within a threshold time comprises generating a fourth distributed ledger transaction effecting at least one of a transfer of at least one of the cryptocurrency value locked in association with the contingent project object and the digital token locked in association with the contingent project object,
wherein the random number generated at least in part from operation of the distributed ledger network,
wherein the random number generated at least in part by utilizing a block time of the distributed ledger network, and
wherein the one or more governance rights comprising a voting right in proportion to at least one of the monetary contribution, the asset contribution, and the service contribution.

14. The method of claim 13, further comprising:
determining the first distribution criteria has been met; and
initiating the first distribution action enabling the second user to initiate a fifth distributed ledger transaction transferring at least one of a cryptocurrency and an electronic token out of the control of the contingent project object.

15. A method for electronic management of crowd sourced projects, the method comprising:
receiving over a network a initialization request from a client device a first user;
generating a contingent project object comprising a unique identifier of the contingent project object and a first referential attribute referencing the user profile of the first user,
wherein the contingent project object is a self-executing contract stored in a distributed ledger database on a node server of a distributed ledger network;
defining a contribution condition for a plurality of users to contribute to the contingent project object, the contribution condition comprising at least one of a monetary contribution that is electronically verifiable, an asset contribution that is electronically verifiable, and a service contribution that is electronically verifiable;
defining an initiation condition data comprising an initiation action and an initiation criteria, where the initiation action is self-executing upon a determination by an initiation evaluation routine that the initiation criteria has been met;
selecting an initiation data source comprising an initiation data necessary as a first input to the initiation evaluation routine to an evaluation of whether the initiation criteria has been met,
wherein the initiation data source comprising at least one of data stored in association with the contingent project object and a first API to an external data source;
generating a project constraint data comprising a project title, an initiation description of the initiation criteria automatically translated from the initiation criteria; and
transmitting the project constraint data to a server computer accessible by one or more of the plurality of users to describe participation constraints of a set of self-executing properties of the contingent project object.

16. The method of claim 15, further comprising:
defining a first distribution condition data comprising a first distribution action and a first distribution criteria, wherein the first distribution action is self-executing upon a determination by a distribution evaluation routine that the first distribution criteria has been met; and
selecting a first distribution data source as a second input to the distribution evaluation routine, the first distribution data source comprising a distribution data that is necessary to an evaluation of whether the initiation criteria has been met,
wherein the project constraint data further comprising a distribution description of the first distribution criteria automatically translated from the first distribution criteria.

17. The method of claim 16, further comprising:
receiving a contribution request from a second user of the plurality of users to contribute at least one of the monetary contribution, the asset contribution, and the service contribution to the contingent project object;
determining the contribution condition has been met;
storing a unique identifier of a user profile of the second user in a second referential attribute; and
associating the unique identifier of the user profile of the second user with the first distribution condition data.

18. The method of claim 17, further comprising:
generating a governance ruleset of the contingent project object, the governance rule set comprising one or more governance rights each associated with at least one of: (i) a user type, and (ii) a unique identifier of the user profile of one of the plurality of users; and
generating a distribution ruleset of the contingent project object, the distribution ruleset comprising a distribution proportion at least partially dependent on at least one of: (i) the user type, (ii) a date of the contribution request of the second user; (iii) a numerical value assigned to the monetary contribution, (iv) a numerical value assigned to the asset contribution, (v) a numerical value assigned to the service contribution, (vi) a qualitative classification value of the monetary contribution, (vii) a qualitative classification value of the asset contribution, and (viii) a qualitative classification value of the service contribution.

19. The method of claim 18, further comprising:
generating a transaction window defining a third distribution action,
wherein the transaction window initiates the third distribution action at a random time for a subset of the plurality of users, and
wherein the subset of the plurality of users is based on at least one of user type, a contribution type contributed by the subset of the plurality of users, a length of association with the contingent project object, and a random group;
generating a random number; and
initiating the transaction window.

20. The method of claim 19,
wherein the monetary contribution comprises at least one of: (i) a transfer of a cryptocurrency value into control of the contingent project object, (ii) a transfer of a digital token into control of the contingent project object, (iii) a first distributed ledger transaction locking the cryptocurrency value in association with the contingent project object, and (iv) a second distributed ledger transaction locking the digital token in association with the contingent project object,
wherein the initiation criteria comprising the contingent project object controlling: (i) a threshold amount of cryptocurrency value, (ii) a threshold number of digital tokens, (iii) a threshold amount of cryptocurrency value that is locked in association with the contingent project object, and (iv) a threshold number of digital tokens that are locked in association with the contingent project object,
wherein the contribution request is included in a third distributed ledger transaction stored on the distributed ledger database comprising the unique identifier of the contingent project object,
wherein a determination that a threshold value has not been met or exceeded within a threshold time comprises generating a fourth distributed ledger transaction effecting at least one of a transfer of at least one of the cryptocurrency value locked in association with the contingent project object and the digital token locked in association with the contingent project object,
wherein the random number generated at least in part from operation of the distributed ledger network,
wherein the random number generated at least in part by utilizing a block time of the distributed ledger network,
wherein the one or more governance rights comprising a voting right in proportion to at least one of the monetary contribution, the asset contribution, and the service contribution, and
wherein at least one of the monetary contribution, the asset contribution, and the service contribution comprise a digital network transaction that comprises receiving data through a second API evidencing completion of the digital network transaction, where the digital network transaction is verifiably associated with the contingent project object and the user profile of one of the plurality of users.
